(19) United States
(12) Patent Application Publication
(10) Pub. No.: US 2025/0341918 A1
(43) Pub. Date: Nov. 6, 2025

(54) TOUCH DISPLAY PANEL AND TOUCH DISPLAY DEVICE

(71) Applicant: Xiamen Tianma Optoelectronics Co., Ltd., Xiamen (CN)

(72) Inventors: Zengjie LIN, Xiamen (CN); Dongquan HOU, Xiamen (CN); Jiaqi KANG, Xiamen (CN); Xiaoxia HONG, Xiamen (CN); Zhe PIAO, Xiamen (CN); Xue YU, Xiamen (CN)

(73) Assignees: Xiamen Tianma Optoelectronics Co., Ltd., Xiamen (CN); Xiamen Tianma Microelectronics Co.,Ltd., Xiamen (CN)

(21) Appl. No.: 19/220,840

(22) Filed: May 28, 2025

(30) Foreign Application Priority Data
Dec. 31, 2024 (CN) 202411997054.X

(51) Int. Cl. G06F 3/041; G06F 3/044

(52) U.S. Cl. CPC G06F 3/0418; G06F 3/0412; G06F 3/04164; G06F 3/04166; G06F 3/0446

(57) ABSTRACT

A touch display panel includes multiple touch electrodes arranged in an array; M adjacent touch electrodes form a touch electrode group. The touch display panel further includes a first control circuit, a second control circuit, multiple gating control lines, multiple common signal lines, multiple switch control lines, and multiple touch fan-out lines. The first control circuit includes multiple multi-channel gating circuits. The second control circuit includes multiple control switches. Control terminals of the control switches are electrically connected to the switch control lines, input terminals of the control switches are electrically connected to the common signal lines, and output terminals of the control switches are electrically connected to the touch electrodes respectively. Control switches electrically connected to adjacent touch electrodes in different touch electrode groups are electrically connected to different common signal lines and different switch control lines respectively.

### CROSS-REFERENCE TO RELATED APPLICATION(S)

This application claims priority to Chinese Patent Application No. 202411997054.X filed Dec. 31, 2024, the disclosure of which is incorporated herein by reference in its entirety.

### TECHNICAL FIELD

Embodiments of the present disclosure relate to the field of display technology and, in particular, to a touch display panel and a touch display device.

### BACKGROUND

At present, display panels with a touch function are widely used in display devices such as mobile phones and wearable devices, and the utilization of these display devices facilitates the simple and convenient implementation of human-machine interaction. Typically, a display panel with the touch function is provided with multiple touch electrodes, and the touch operation is achieved by detecting the signal variation amount on the multiple touch electrodes.

In the visual testing (VT) detection stage of the related art, touch detection is generally performed by checking a checkerboard pattern to confirm whether a touch signal is transmitted normally. However, based on the structure of a touch display panel in the related art, it is impossible to detect whether touch fan-out lines in the touch display panel are short-circuited, resulting in reduced reliability of the touch detection.

### SUMMARY

In view of this, the present disclosure provides a touch display panel and a touch display device.

In a first aspect, the present disclosure provides a touch display panel. The touch display panel includes a display region and a non-display region surrounding the display region.

The display region includes a plurality of touch electrodes arranged in an array; among the plurality of touch electrodes, M adjacent touch electrodes form a touch electrode group; M is a positive integer greater than or equal to 2.

The non-display region includes a first control circuit, a second control circuit, a plurality of gating control lines, a plurality of common signal lines, a plurality of switch control lines, and a plurality of touch fan-out lines.

The first control circuit includes a plurality of multi-channel gating circuits; a multi-channel gating circuit of the plurality of multi-channel gating circuits includes a plurality of gating switches; in a same multi-channel gating circuit, control terminals of the plurality of gating switches are electrically connected to different ones of the plurality of gating control lines respectively, first terminals of the plurality of gating switches are electrically connected to a same one of the plurality of touch fan-out lines, and second terminals of the plurality of gating switches are electrically connected to touch electrodes in a same touch electrode group respectively.

The second control circuit includes a plurality of control switches; control terminals of the plurality of control switches are electrically connected to the plurality of switch control lines, input terminals of the plurality of control switches are electrically connected to the plurality of common signal lines, and output terminals of the plurality of control switches are electrically connected to the plurality of touch electrodes respectively, where among the plurality of control switches, control switches electrically connected to adjacent touch electrodes belonging to different touch electrode groups are electrically connected to different ones of the plurality of common signal lines respectively, and are electrically connected to different ones of the plurality of switch control lines respectively.

In a second aspect, the present disclosure provides a touch display device. The touch display device includes the touch display panel described in the first aspect of the present disclosure.

### BRIEF DESCRIPTION OF DRAWINGS

FIG. 1 is a cross-sectional diagram of a touch display panel according to one or more embodiments of the present disclosure.

FIG. 2 is a diagram illustrating the structure of a touch display panel in the related art according to one or more embodiments of the present disclosure.

FIG. 3 is a diagram illustrating the structure of a touch display panel according to one or more embodiments of the present disclosure.

FIG. 4 is another diagram illustrating the structure of a touch display panel according to one or more embodiments of the present disclosure.

FIG. 5 is yet another diagram illustrating the structure of a touch display panel according to one or more embodiments of the present disclosure.

FIG. 6 is still another diagram illustrating the structure of a touch display panel according to one or more embodiments of the present disclosure.

FIG. 7 is still another diagram illustrating the structure of a touch display panel according to one or more embodiments of the present disclosure.

FIG. 8 is still another diagram illustrating the structure of a touch display panel according to one or more embodiments of the present disclosure.

FIG. 9 is still another diagram illustrating the structure of a touch display panel according to one or more embodiments of the present disclosure.

FIG. 10 is still another diagram illustrating the structure of a touch display panel according to one or more embodiments of the present disclosure.

FIG. 11 is still another diagram illustrating the structure of a touch display panel according to one or more embodiments of the present disclosure.

FIG. 12 is still another diagram illustrating the structure of a touch display panel according to one or more embodiments of the present disclosure.

FIG. 13 is still another diagram illustrating the structure of a touch display panel according to one or more embodiments of the present disclosure.

FIG. 14 is still another diagram illustrating the structure of a touch display panel according to one or more embodiments of the present disclosure.

FIG. 15 is a cross-sectional diagram of FIG. 9 taken along an A-A′ direction.

FIG. 16 is another cross-sectional diagram of FIG. 9 taken along an A-A′ direction.

FIG. 17 is still another diagram illustrating the structure of a touch display panel according to one or more embodiments of the present disclosure.

FIG. 18 is still another diagram illustrating the structure of a touch display panel according to one or more embodiments of the present disclosure.

FIG. 19 is still another diagram illustrating the structure of a touch display panel according to one or more embodiments of the present disclosure.

FIG. 20 is a diagram illustrating the structure of a touch display device according to one or more embodiments of the present disclosure.

### DETAILED DESCRIPTION

The present disclosure is further described in detail below in conjunction with the drawings and embodiments. The embodiments described herein are intended to illustrate the present disclosure and not to limit the present disclosure. Additionally, for ease of description, only part, not all, of the structures related to the present disclosure are illustrated in the drawings.

Terms such as “having”, “including”, and “comprising” described in the present disclosure are all open-ended meanings, that is, when a module is described as “having”, “including”, or “comprising” a first element, a second element and/or a third element, it means that the module further includes not only the first element, the second element and/or the third element but also other elements. Additionally, ordinal numbers such as “first”, “second” and “third” in the present disclosure are not intended to limit a specific order, but only to distinguish between various sections. When the present disclosure describes that layer A and layer B are “disposed in the same layer”, it means that layer A and layer B are made of the same material in the same process.

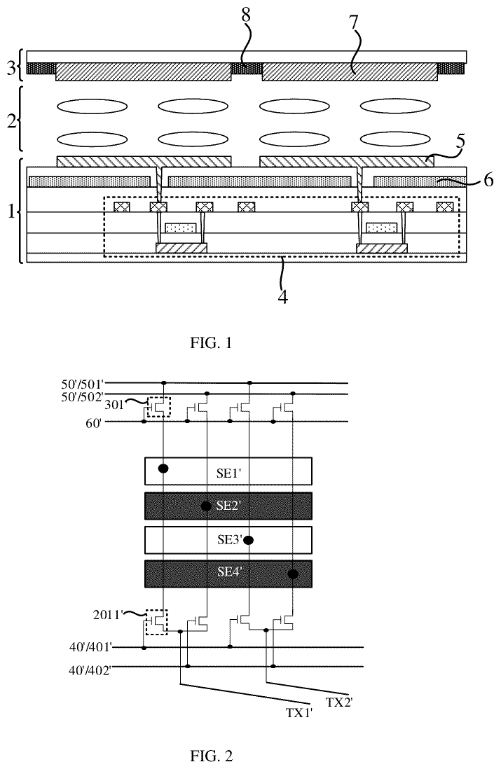

In-cell technology embeds touch panel functions into display panels to achieve thinner and lighter panels. In a touch display panel based on the in-cell architecture, common electrodes (or cathodes) of pixels in the touch display panel are also used as touch electrodes. A touch display panel in the embodiment of the present disclosure may be a liquid-crystal display panel or an organic light-emitting diode display panel, which is not limited in the embodiment of the present disclosure. The liquid-crystal display panel is used as an example for description in the following embodiments. FIG. 1 is a cross-sectional diagram of a touch display panel according to one or more embodiments of the present disclosure. As shown in FIG. 1, the liquid-crystal touch display panel may include a drive substrate 1, a liquid crystal layer 2, and a color film substrate 3 that are stacked. The drive substrate 1 includes a structure of a pixel, such as a pixel circuit 4, a pixel electrode 5, and a common electrode 6. The color film substrate 3 includes a color resist structure 7 of the pixel, a black matrix 8 located between at least two adjacent color resist structures 7, and others. The pixel circuit 4 may be electrically connected to the pixel electrode 5 to provide the pixel electrode 5 with a data signal required for display. The common electrode 6 may receive a common signal. The liquid crystal layer 2 includes liquid crystal molecules. An electric field generated between the common electrode 6 and the pixel electrode 5 may drive the liquid crystal molecules to twist to control the transmission amount of a backlight source provided by a backlight module so that the pixel can display a corresponding color and brightness.

FIG. 1 exemplarily shows that the pixel electrode 5 and the common electrode 6 are located on the same side of the liquid crystal layer 2, which is not actually limited thereto. When the pixel electrode 5 and the common electrode 6 are disposed on the same side of the liquid crystal layer 2, the touch display panel is a flat control mode display panel, such as a fringe field switching (FFS) display panel or an in-plane switching (IPS) display panel. In other embodiments of the present disclosure, the pixel electrode 5 and the common electrode 6 may also be disposed on two sides of the liquid crystal layer 2 respectively so that a vertical control mode display panel can be formed, such as a twisted nematic (TN) display panel or a multi-quadrant vertical alignment (VA) display panel. Additionally, in the touch display panel shown in FIG. 1, the pixel electrode 5 is located between the common electrode 6 and the liquid crystal layer 2, that is, the pixel electrode 5 is closer to the liquid crystal layer 2, which is not actually limited thereto. In other embodiments, the pixel electrode 5 may be located on a side of the common electrode 6 facing away from the liquid crystal layer 2, that is, the common electrode 6 is closer to the liquid crystal layer 2, which is not limited in the embodiment of the present disclosure. For ease of description, the structure of the touch display panel shown in FIG. 1 is used as an example in embodiments of the present disclosure to describe the technical solutions in the embodiments of the present disclosure.

With continued reference to FIG. 1, for a touch liquid-crystal display panel with an integrated touch function, the common electrode 6 may also be used as a touch electrode. The driving process of the touch display panel may include a display stage and a touch stage. In the display stage, a display common signal is provided to the common electrode 6 to form the electric field between the common electrode 6 and the pixel electrode 5 so as to drive the liquid crystal molecules to twist and display an image. In the touch stage, a touch driving signal and/or a touch sensing signal are provided to the common electrode 6 to detect the touch position of a touch object such as a finger or a stylus.

The touch electrodes may be electrically connected to a touch driver chip through touch fan-out lines in a non-display region. To optimize the layout of the touch fan-out lines, a multi-channel gating circuit architecture is proposed. In the multi-channel gating circuit architecture, different touch electrodes are electrically connected to the same touch fan-out line through gating switches. Exemplarily, FIG. 2 is a diagram illustrating the structure of a touch display panel in the related art according to one or more embodiments of the present disclosure. In the related art, a touch electrode SE1′ and a touch electrode SE2′ are electrically connected to a touch fan-out line TX1′ through corresponding gating switches 2011′ respectively, a touch electrode SE3′ and a touch electrode SE4′ are electrically connected to a touch fan-out line TX2′ through corresponding gating switches 2011′ respectively, a gating switch 2011′ connected to the touch electrode SE1′ and a gating switch 2011′ connected to the touch electrode SE3′ are electrically connected to the same gating control line 40′ (a first gating control line 401′), and a gating switch 2011′ connected to the touch electrode SE2′ and a gating switch 2011′ connected to the touch electrode SE4′ are electrically connected to the same gating control line 40′ (a second gating control line 402′). In this manner, the first gating control line 401′ and the second gating control line 402′ are configured to transmit different gating control signals respectively, and the gating switches 2011′ electrically connected to the touch electrode SE1′ and the touch electrode SE2′ can be controlled to turn on or off so that the touch electrode SE1′ and the touch electrode SE2′ can receive a touch driving signal transmitted by the touch fan-out line TX1′ in a time-sharing manner and provide a touch sensing signal for the touch fan-out line TX1′ in a time-sharing manner. Similarly, the touch electrode SE3′ and the touch electrode SE4′ can receive a touch driving signal transmitted by the touch fan-out line TX2′ in a time-sharing manner and provide a touch sensing signal for the touch fan-out line TX2′ in a time-sharing manner.

Additionally, to perform touch detection on the touch display panel in the visual testing (VT) detection stage, the touch display panel is also provided with a control switch 301′, a common signal line 50′, and a switch control line 60′ that are electrically connected to the touch electrodes. As shown in FIG. 2, in the related art, control switches 301′ connected to touch electrodes (SE1′, SE2′, SE3′, and SE4′) respectively are electrically connected to the same switch control line 60′; input terminals of control switches 301′ connected to the touch electrode SE1′ and the touch electrode SE3′ are connected to a first common signal line 501′, and input terminals of control switches 301′ connected to the touch electrode SE2′ and the touch electrode SE4′ are connected to a second common signal line 502′. In the touch detection stage of the VT detection stage, a low-level signal (for example, a voltage of 0 V) may be provided to pixel electrodes, and an enable level of a switch control signal may be provided to the switch control line 60′ to control the control switches 301′ to be in an on state; in the meantime, a high-level common signal (for example, a voltage of 5 V) may be provided to the first common signal line 501′, and a low-level common signal (for example, a voltage of 0 V) may be provided to the second common signal line 502′. Based on this arrangement, liquid crystal molecules of some pixels corresponding to the touch electrode SE1′ and the touch electrode SE3′ can be twisted to the greatest extent under the action of electric fields between the touch electrode SE1′ and the touch electrode SE3′ and pixel electrodes, and the overall display color of these pixels can be white; liquid crystal molecules of other pixels corresponding to the touch electrode SE2′ and the touch electrode SE4′ cannot be twisted, and backlight cannot pass through the other pixels so that the display color of the other pixels can be black. In this manner, different common signals are provided to different touch electrodes respectively, and a checkerboard pattern is presented in the display region of the touch display panel. In this case, whether the touch electrodes can accurately receive touch signals can be detected by observing whether the display region of the touch display panel presents the checkerboard pattern.

However, the inventors have found through research that when the preceding solutions are adopted, it is impossible to detect a short circuit between two adjacent touch fan-out lines. Exemplarily, when the first gating control line 401′ and the second gating control line 402′ both provide non-enable levels of gating control signals, the gating switches 2011′ are turned off, the touch electrode SE1′ and the touch electrode SE3′ both receive a voltage of 5 V, and the touch electrode SE2′ and the touch electrode SE4′ both receive a voltage of 0 V; the display color of the pixels corresponding to the touch electrode SE1′ and the touch electrode SE3′ is white, and the display color of other pixels corresponding to the touch electrode SE2′ and the touch electrode SE4′ is black; in this case, the short circuit between the touch fan-out line TX1′ and the touch fan-out line TX2′ has no effect on the display image, so whether the touch fan-out lines are short-circuited cannot be determined based on the current display image. When the first gating control line 401′ and the second gating control line 402′ both provide enable levels of the gating control signals, if the touch fan-out line TX1′ and the touch fan-out line TX2′ are not short-circuited, the touch electrode SE1′ and the touch electrode SE2′ form a loop, the touch electrode SE3′ and the touch electrode SE4′ form a loop, and the touch electrodes receive both voltages of 0 V and 5 V so that the display colors of the pixels corresponding to all the touch electrodes can be gray; if the touch fan-out line TX1′ and the touch fan-out line TX2′ are short-circuited, a loop is formed between any two touch electrodes, since the display colors in the positions of the touch electrodes are all gray, it is impossible to determine whether the touch fan-out lines are short-circuited or not by observing the current display pattern. When one of the first gating control line 401′ and the second gating control line 402′ provides an enable level of a gating control signal, and the other one of the first gating control line 401′ and the second gating control line 402′ provides a non-enable level of the gating control signal, regardless of whether the touch fan-out line TX1′ and the touch fan-out line TX2′ are short-circuited or not, the touch electrode SE1′ and the touch electrode SE3′ both receive a voltage of 5 V, the touch electrode SE2′ and the touch electrode SE4′ both receive a voltage of 0V, the display colors of some pixels corresponding to the touch electrode SE1′ and the touch electrode SE3′ are white, and the display colors of other pixels corresponding to the touch electrode SE2′ and the touch electrode SE4′ are black, thus, it is also impossible to determine whether the touch fan-out lines are short-circuited or not based on the current display pattern.

In summary, no matter what signal transmission manner is adopted for the touch display panel in the related art in the VT detection stage, it is impossible to determine whether adjacent touch fan-out lines are short-circuited or not. Based on the problems in the related art, embodiments of the present disclosure provide a touch display panel. The touch display panel includes a display region and a non-display region surrounding the display region. The display region includes multiple touch electrodes arranged in an array; M adjacent touch electrodes form a touch electrode group; M is a positive integer greater than or equal to 2. The non-display region includes a first control circuit, a second control circuit, multiple gating control lines, multiple common signal lines, multiple switch control lines, and multiple touch fan-out lines. The first control circuit includes multiple multi-channel gating circuits; a multi-channel gating circuit includes multiple gating switches. In the same multi-channel gating circuit, control terminals of the gating switches are electrically connected to different gating control lines respectively, first terminals of the gating switches are electrically connected to the same touch fan-out line, and second terminals of the gating switches are electrically connected to the touch electrodes in the same touch electrode group respectively. The second control circuit includes multiple control switches. Control terminals of the control switches are electrically connected to the switch control lines, input terminals of the control switches are electrically connected to the common signal lines, and output terminals of the control switches are electrically connected to the touch electrodes respectively. Control switches electrically connected to adjacent touch electrodes belonging to different touch electrode groups are electrically connected to different common signal lines respectively and are electrically connected to different switch control lines respectively.

With the preceding solutions adopted, in the touch short-circuit detection stage, different common signals are provided to adjacent touch electrodes belonging to the different touch electrode groups, and a checkerboard pattern is presented in the display region in units of the touch electrode groups. With this solution, the short circuit in the touch fan-out lines can be determined according to the presented checkerboard pattern, thereby improving the detection capability of the short circuit in the touch fan-out lines and improving the reliability of touch detection.

The preceding is the core idea of the present disclosure. The technical solutions in the embodiments of the present disclosure are described clearly and completely hereinafter in conjunction with the drawings in the embodiments of the present disclosure. Based on the embodiments of the present disclosure, all other embodiments obtained by those of ordinary skill in the art without any creative efforts are within the scope of the present disclosure.

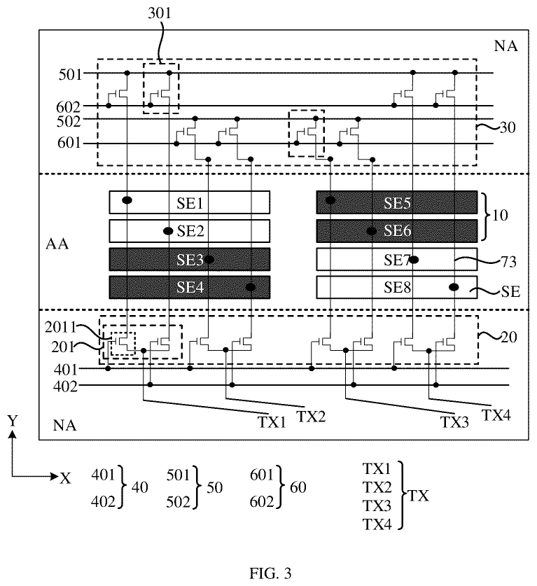

FIG. 3 is a diagram illustrating the structure of a touch display panel according to one or more embodiments of the present disclosure. Referring to FIG. 3, in the embodiment of the present disclosure, the touch display panel includes a display region AA and a non-display region NA surrounding the display region AA. The display region AA includes multiple touch electrodes SE arranged in an array; M adjacent touch electrodes SE form a touch electrode group 10; M is a positive integer greater than or equal to 2. The non-display region NA includes a first control circuit 20, a second control circuit 30, multiple gating control lines 40, multiple common signal lines 50, multiple switch control lines 60, and multiple touch fan-out lines TX. The first control circuit 20 includes multiple multi-channel gating circuits 201; a multi-channel gating circuit 201 includes multiple gating switches 2011. In the same multi-channel gating circuit 201, control terminals of the gating switches 2011 are electrically connected to different gating control lines 40 respectively, first terminals of the gating switches 2011 are electrically connected to the same touch fan-out line TX, and second terminals of the gating switches 2011 are electrically connected to the touch electrodes SE in the same touch electrode group 10 respectively. The second control circuit 30 includes multiple control switches 301. Control terminals of the control switches 301 are electrically connected to the switch control lines 60, input terminals of the control switches 301 are electrically connected to the common signal lines 50, and output terminals of the control switches 301 are electrically connected to the touch electrodes SE respectively. Control switches 301 electrically connected to adjacent touch electrodes SE belonging to different touch electrode groups 10, are electrically connected to different common signal lines 50 respectively and are electrically connected to different switch control lines 60 respectively.

In the technical solutions of the present disclosure, the control switches electrically connected to adjacent touch electrodes belonging to different touch electrode groups are electrically connected to different common signal lines and different switch control lines respectively, thus different common signals are provided to adjacent touch electrodes belonging to different touch electrode groups in the touch short-circuit detection stage, and a checkerboard pattern is presented in the display region in units of the touch electrode groups. With this solution, a short circuit in the touch fan-out lines can be determined according to the presented checkerboard pattern, thereby improving the detection capability of the short circuit in the touch fan-out lines and improving the reliability of the touch detection.

The display region AA is configured to fulfill the image display and touch function of the display panel. As shown in FIG. 3, the display region AA is provided with the multiple touch electrodes SE arranged in an array along the row direction X and the column direction Y. The M touch electrodes SE adjacent to each other along the row direction X or the column direction Y form one touch electrode group 10. The display region AA includes multiple touch electrode groups 10 arranged in an array. The figure shows part of the display region AA and touch electrode groups 10 in the part of display region AA, and does not show all the touch electrode groups 10 in the display region AA. It is known to those skilled in the art that the touch display panel should include the multiple touch electrode groups 10 arranged as shown in FIG. 3.

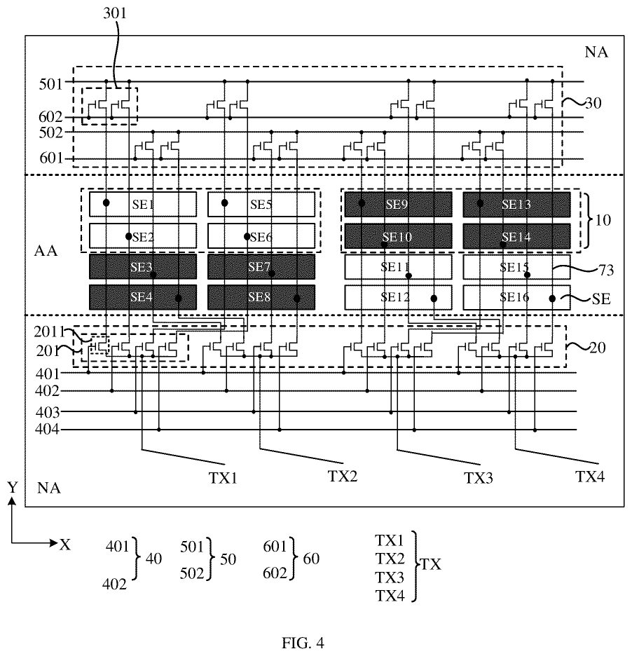

The number and specific arrangement of touch electrodes SE in one touch electrode group 10 is not limited in the embodiment of the present disclosure. FIG. 3 exemplarily uses M being 2 and the one touch electrode group 10 including two touch electrodes SE arranged along the column direction Y as an example. In other embodiments of the present disclosure, FIG. 4 is another diagram illustrating the structure of a touch display panel according to one or more embodiments of the present disclosure. Referring to FIG. 4, M may be four, and the one touch electrode group 10 includes four touch electrodes SE that are arranged along the row direction X and the column direction Y. In one or more embodiments not shown in the present disclosure, M may be any integer greater than or equal to 2, and the arrangement of the touch electrodes SE in the same touch electrode group 10 may be designed according to the actual needs, which are not limited in the embodiment of the present disclosure.

With continued reference to FIGS. 3 and 4, the non-display region NA surrounds at least part of the display region AA, and the non-display region NA is a bezel region configured to arrange related wire components and not to display an image. In the embodiment of the present disclosure, the non-display region NA is provided with the first control circuit 20, the second control circuit 30, the common signal lines 50, the switch control lines 60, the touch fan-out lines TX, and others.

The first control circuit 20 includes the multiple multi-channel gating circuits 201. The number of multi-channel gating circuits 201 may be the same as the number of touch electrode groups 10. One multi-channel gating circuit 201 includes the multiple gating switches 2011. The number of gating switches 2011 may be the same as the number of the touch electrodes SE in one touch electrode group 10. Exemplarily, as shown in FIG. 3, one multi-channel gating circuit 201 includes two gating switches 2011, or as shown in FIG. 4, one multi-channel gating circuit 201 includes four gating switches 2011.

With continued reference to FIGS. 3 and 4, the control terminals of the gating switches 2011 are electrically connected to the gating control lines 40 respectively, the first terminals of the gating switches 2011 are electrically connected to the touch fan-out line TX, and the second terminals of the gating switches 2011 are electrically connected to the touch electrodes SE respectively; the other terminal of the touch fan-out line TX may be connected to a driver chip (not shown in the figures).

A touch electrode SE may be a mutual-capacitive touch electrode or a self-capacitive touch electrode. When the touch electrodes SE are mutual-capacitive touch electrodes, the touch electrodes SE may be touch driving electrodes or touch sensing electrodes. When the touch electrodes SE are the touch driving electrodes, the driver chip may provide touch driving signals for the touch electrodes SE through the touch fan-out lines TX and the gating switches 2011. When the touch electrodes SE are the touch sensing electrodes, the driver chip may receive touch sensing signals fed back by the touch electrodes SE through the touch fan-out lines TX and the gating switches 2011. When the touch electrodes SE are self-capacitive touch electrodes, in the touch driving stage, the driver chip may provide the touch driving signals for the touch electrodes SE through the touch fan-out lines TX and the gating switches 2011, and in the touch sensing stage, the driver chip may receive the touch sensing signals fed back by the touch electrodes SE through the touch fan-out lines TX and the gating switches 2011. The specific touch mode of the touch electrode SE may be designed according to the actual needs, which is not limited in the embodiment of the present disclosure. For ease of description, unless special limitations are made, the technical solutions of the embodiments of the present disclosure are illustrated using an example in which the touch electrode is a touch driving electrode of the mutual-capacitive touch electrode in the embodiments of the present disclosure.

With continued reference to FIGS. 3 and 4, since the control terminals of the gating switches 2011 are electrically connected to the gating control lines 40 respectively, the gating switches 2011 can be turned on or off under the control of gating control signals transmitted by the gating control lines 40, and when the gating switches 2011 are turned on, touch signals transmitted by the touch fan-out lines TX can be written to the touch electrodes SE. The type of a gating switch 2011 may be designed according to the actual needs, which is not limited in the embodiment of the present disclosure. In one or more embodiments, the gating switch 2011 may include a transistor, which is not limited thereto. When the gating switch 2011 includes the transistor, a control terminal of the gating switch 2011 may be referred to as a gate of the transistor, a first terminal of the gating switch 2011 may be referred to as a source of the transistor, and a second terminal of the gating switch 2011 may be referred to as a drain of the transistor; or a control terminal of the gating switch 2011 may be referred to as the gate of the transistor, a first terminal of the gating switch 2011 may be referred to as the drain of the transistor, and a second terminal of the gating switch 2011 may be referred to as the source of the transistor.

Different gating switches 2011 in the same multi-channel gating circuit 201 are connected to different gating control lines 40 respectively, and the gating switches 2011 in the same multi-channel gating circuit 201 are connected to the same touch fan-out line TX; the different gating switches 2011 in the same multi-channel gating circuit 201 are connected to different touch electrodes SE in the same touch electrode group 10 respectively, and the gating switches 2011 are electrically connected to the touchable electrodes SE in one-to-one correspondence, that is, the M touch electrodes SE in the same touch electrode group 10 are electrically connected to one touch fan-out line TX through M gating switches 2011 in the same multi-channel gating circuit 201. In this manner, one touch fan-out line TX can provide touch driving signals to the M touch electrodes SE in a time-sharing manner, thereby reducing the number of touch fan-out lines TX, optimizing the layout of the touch fan-out lines TX in the non-display region NA, reducing the number of connection terminals between the driver chip and the touch fan-out lines TX, and reducing the manufacturing cost and difficulty of the driver chip.

The number of gating control lines 40 may be the same as the number of touch electrodes SE in the touch electrode group 10. As shown in FIG. 3, the gating control lines 40 may include a first gating control line 401 and a second gating control line 402. The first gating control line 401 is connected to one gating switch 2011 in each multi-channel gating circuit 201, and the second gating control line 402 is electrically connected to the other gating switch 2011 in each multi-channel gating circuit 201. Alternatively, as shown in FIG. 4, the gating control lines 40 may include a first gating control line 401, a second gating control line 402, a third gating control line 403, and a fourth gating control line 404 that are electrically connected to four gating switches 2011 in the same multi-channel gating circuit 201 respectively. When transmitting enable levels of the gating control signals in a time-sharing manner, the gating control lines 40 may control the gating switches 2011 in the same multi-channel gating circuit 201 to turn on in a time-sharing manner so as to provide the touch driving signals to the touch electrodes SE in the same touch electrode group 10 in a time-sharing manner.

With continued reference to FIGS. 3 and 4, the second control circuit 30 includes the multiple control switches 301. The control terminals of the control switches 301 are electrically connected to the switch control lines 60, the input terminals of the control switches 301 are electrically connected to the common signal lines 50, and the output terminals of the control switches 301 are electrically connected to the touch electrodes SE respectively. The control switches 301 are turned on or off under the control of switch control signals transmitted by the switch control lines 60. When the control switches 301 are turned on, common signals provided by the common signal lines 50 may be transmitted to the touch electrodes SE. The number of control switches 301 may be the same as the number of touch electrodes SE so that the control switches 301 can be connected to the touch electrodes SE in one-to-one correspondence.

The number of switch control lines 60 and the number of common signal lines 50 are not limited and may be designed by those skilled in the art according to the actual needs. Exemplarily, in some embodiments, the multiple switch control lines 60 may include a first switch control signal line 601 and a second switch control signal line 602, and the multiple common signal lines 50 may include a first common signal line 501 and a second common signal line 502. The first switch control signal line 601 and the second switch control signal line 602 are electrically connected to different control switches 301 respectively, and the first common signal line 501 and the second common signal line 502 are electrically connected to different control switches 301 respectively.

The second control circuit 30 may be configured to provide testing common signals for the touch electrodes SE in the VT detection stage to detect the touch function of the touch display panel before the touch display panel is delivered from the factory. When the touch electrodes SE are also used as common electrodes of pixels in the touch display panel, the second control circuit 30 may also provide display common signals for the touch electrodes SE in the display stage during the normal use of the touch display panel to quickly charge the common electrodes of the touch display panel after the touch display panel is delivered from the factory.

In an exemplary embodiment, the touch display panel may also be provided with multiple testing pads, multiple data terminals, and multiple signal transmission lines. The testing pads may be configured to receive testing signals such as testing common signals, switch control signals, and gating control signals. The data terminals are configured to bind the driver chip or a flexible circuit board and receive display common signals, switch control signals, gating control signals, and others provided by the driver chip or the flexible circuit board. First terminals of the signal transmission lines are electrically connected to the common signal lines, the gating control signal lines, the switch control signal lines, and others respectively, second terminals of the signal transmission lines are electrically connected to the data terminals respectively, and the testing pads are electrically connected between the first terminals of the signal transmission lines and the second terminals of the signal transmission lines respectively. In this manner, when VT detection is performed, corresponding testing signals may be provided through the testing pads and may be transmitted to the common signal lines, the gating control signal lines, the switch control signal lines, and the others through the signal transmission lines respectively so as to control the gating switches and the control switches to turn on or off respectively and control the turned-on gating switches and the turned-on control switches to transmit the corresponding testing signals to the touch electrodes to test the touch function. Moreover, in the display stage, the data terminals may receive display signals (such as the display common signals) provided by the driver chip or the flexible circuit board and provide the display signals to the common signal lines, the gating control signal lines, the switch control signal lines, and the others through the signal transmission lines respectively so as to control the gating switches and the control switches to turn on or off respectively so that the turned-on gating switches and the turned-on control switches can simultaneously transmit the display signals to the touch electrodes and so that the touch electrodes can also be used as the common electrodes and control the display light emission brightness of the pixels together with pixel electrodes.

In this embodiment, to detect the short circuit in the touch fan-out lines TX, the control switches 301 corresponding to the touch electrodes SE that are adjacent along the row direction X or the column direction Y but belong to the different touch electrode groups 10 may be configured to be electrically connected to the different common signal lines 50 and the different switch control lines 60 respectively, that is, the control switches 301 corresponding to adjacent touch electrodes SE belonging to the different touch electrode groups 10 are controlled by switch control signals transmitted by the different switch control lines 60, so that the control switches 301 can be turned on or off, and when the control switches 301 are turned on, the adjacent touch electrodes SE belonging to the different touch electrode groups 10 can receive the different common signals.

In an exemplary embodiment, as shown in FIG. 3, a touch electrode SE2 and a touch electrode SE3 are two adjacent touch electrodes SE located in different touch electrode groups 10, a touch electrode SE1 and a touch electrode SE5 are two adjacent touch electrodes SE located in different touch electrode groups 10, the touch electrode SE2 and a touch electrode SE6 are two adjacent touch electrodes SE located in different touch electrode groups 10, the touch electrode SE6 and a touch electrode SE7 are two adjacent touch electrodes SE located in different touch electrode groups 10, the touch electrode SE3 and the touch electrode SE7 are two adjacent touch electrodes SE located in different touch electrode groups 10, a touch electrode SE4 and a touch electrode SE8 are two adjacent touch electrodes SE located in different touch electrode groups 10, and so on. Control terminals of two control switches 301 electrically connected to the touch electrode SE2 and the touch electrode SE3 (the touch electrode SE1 and the touch electrode SE5; or the touch electrode SE2 and the touch electrode SE6) are connected to the second switch control line 602 and the first switch control line 601 respectively. Input terminals of the two control switches 301 electrically connected to the touch electrode SE2 and the touch electrode SE3 (the touch electrode SE1 and the touch electrode SE5; or the touch electrode SE2 and the touch electrode SE6) are connected to the first common signal line 501 and the second common signal line 502 respectively. Similarly, control terminals of two control switches 301 electrically connected to the touch electrode SE6 and the touch electrode SE7 (the touch electrode SE3 and the touch electrode SE7; or the touch electrode SE4 and the touch electrode SE8) are connected to the first switch control line 601 and the second switch control line 602 respectively. Input terminals of the two control switches 301 electrically connected to the touch electrode SE6 and the touch electrode SE7 (the touch electrode SE3 and the touch electrode SE7; or the touch electrode SE4 and the touch electrode SE8) are connected to the second common signal line 502 and the first common signal line 501 respectively.

In another exemplary embodiment, as shown in FIG. 4, the adjacent touch electrodes located in the different touch electrode groups 10 may include any one of the touch electrode SE2 and the touch electrode SE3, the touch electrode SE6 and the touch electrode SE7, the touch electrode SE5 and a touch electrode SE9, the touch electrode SE6 and a touch electrode SE10, the touch electrode SE10 and a touch electrode SE11, a touch electrode SE14 and a touch electrode SE15, the touch electrode SE7 and the touch electrode SE11, the touch electrode SE8 and a touch electrode SE12, or others. Control terminals of two control switches 301 electrically connected to the touch electrode SE2 and the touch electrode SE3 (the touch electrode SE6 and the touch electrode SE7, the touch electrode SE5 and the touch electrode SE9, or the touch electrode SE6 and the touch electrode SE10) are connected to the second switch control line 602 and the first switch control line 601 respectively. Input terminals of the two control switches 301 electrically connected to the touch electrode SE2 and the touch electrode SE3 (the touch electrode SE6 and the touch electrode SE7, the touch electrode SE5 and the touch electrode SE9, or the touch electrode SE6 and the touch electrode SE10) are connected to the first common signal line 501 and the second common signal line 502 respectively. Control terminals of two control switches 301 electrically connected to the touch electrode SE10 and the touch electrode SE11 (the touch electrode SE14 and the touch electrode SE15, the touch electrode SE7 and the touch electrode SE11, or the touch electrode SE8 and the touch electrode SE12) are connected to the first switch control line 601 and the second switch control line 602 respectively. Input terminals of the two control switches 301 electrically connected to the touch electrode SE10 and the touch electrode SE11 (the touch electrode SE14 and the touch electrode SE15, the touch electrode SE7 and the touch electrode SE11, or the touch electrode SE8 and the touch electrode SE12) are connected to the second common signal line 502 and the first common signal line 501 respectively.

The preceding is only exemplarily described by using the touch display panel including two common signal lines 50 as an example, and in the embodiment of the present disclosure, the number of common signal lines may be designed according to the actual needs, which is not limited in the embodiment of the present disclosure. When the touch display panel includes the multiple common signal lines 50, at least some of the common signal lines 50 may transmit different common signals so that adjacent touch electrodes SE belonging to different touch electrode groups 10 can receive the different common signals and display colors of the pixels corresponding to the adjacent touch electrodes SE belonging to the different touch electrode groups 10 are different, thus when gating switches electrically connected to the adjacent touch electrodes SE belonging to the different touch electrode groups 10 are controlled to turn on, a short circuit in adjacent touch fan-out lines TX can be determined according to the display colors of the pixels corresponding to the two touch electrodes SE.

The specific implementation manner of detecting the short circuit in the touch fan-out lines TX may be designed according to the actual needs, which is not limited in the embodiment of the present disclosure.

In one or more embodiments, a working stage of the touch display panel includes the touch short-circuit detection stage; in the touch short-circuit detection stage, the common signal lines 50 are configured to transmit different common signals respectively.

The touch short-circuit detection stage may be performed in the VT detection stage. In the touch short-circuit detection stage, the adjacent touch electrodes SE belonging to the different touch electrode groups 10 receive the different common signals so that a checkerboard pattern is presented in the display region AA in units of the touch electrode group 10. Moreover, since multi-channel gating circuits 201 corresponding to different touch electrode groups 10 are connected to different touch fan-out lines TX, when touch fan-out lines TX corresponding to adjacent multi-channel gating circuits 201 are not short-circuited, the potentials of touch electrodes SE in adjacent touch electrode groups 10 are different (the potentials corresponding to different common signals respectively) so that pixels corresponding to the touch electrodes SE in the adjacent touch electrode groups 10 can display different colors respectively. When the touch fan-out lines TX corresponding to the adjacent multi-channel gating circuits 201 are short-circuited, a loop is formed between the touch electrodes SE in the adjacent touch electrode groups 10, and the potentials of the touch electrodes SE in the adjacent touch electrode groups 10 are the same (the potential value between the potentials corresponding to the different common signals). In this case, the pixels forming the loop and corresponding to the touch electrodes SE in the different touch electrode groups 10, display the same color. On this basis, the short circuit in the touch fan-out lines TX can be determined according to the checkerboard pattern presented in the display region AA.

In an exemplary embodiment, using the touch display panel shown in FIG. 3 as an example, in the touch short-circuit detection stage, enable levels of switch control signals can be provided to the first switch control line 601 and the second switch control line 602 so that the control switches 301 can be all turned on. The first common signal line 501 transmits a high-level testing common signal (for example, a voltage of 5 V), and the second common signal line 502 transmits a low-level testing common signal (for example, a voltage of 0 V); enable levels of gating control signals may be provided to both the first gating control line 401 and the second gating control line 402 so that the gating switches 2011 can be turned on; if a touch fan-out line TX1 and a touch fan-out line TX2 electrically connected to the touch electrode SE2 and the touch electrode SE3 are not short-circuited, the display colors of pixels corresponding to the touch electrode SE2 and the touch electrode SE3 are white and black respectively (as shown in FIG. 3).

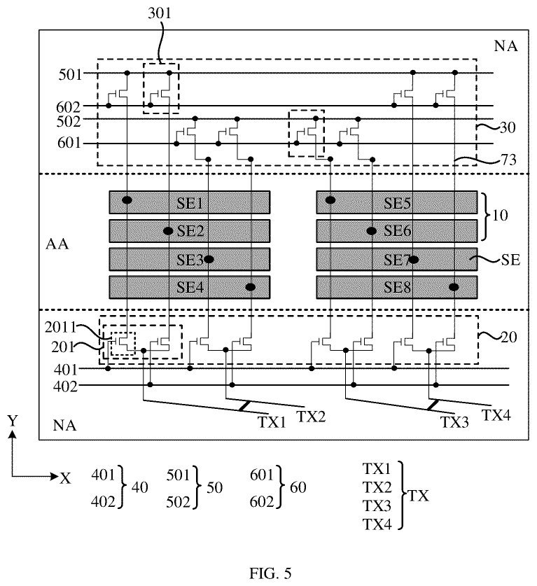

In another exemplary embodiment, FIG. 5 is yet another diagram illustrating the structure of a touch display panel according to one or more embodiments of the present disclosure. Referring to FIG. 5, if the touch fan-out line TX1 and the touch fan-out line TX2 corresponding to the touch electrode SE2 and the touch electrode SE3 are short-circuited, the potentials of the touch electrode SE2 and the touch electrode SE3 are the same and ranges from 0 V to 5 V, and the display colors of the pixels corresponding to the touch electrode SE2 and the touch electrode SE3 are both gray. Therefore, whether the touch fan-out line TX1 and the touch fan-out line TX2 are short-circuited can be determined by observing the display colors of the pixels corresponding to the touch electrode SE2 and the touch electrode SE3. Alternatively, in other optional embodiments, for the situation shown in FIG. 3, the enable levels of the gating control signals may also be provided to one of the first gating control line 401 and the second gating control line 402 so that gating switches 2011 electrically connected to the first gating control line 401 or the second gating control line 402 can be turned on, and the other gating switches 2011 can be turned off. Whether the touch fan-out line TX1 and the touch fan-out line TX2 are short-circuited is determined by observing the display colors of pixels corresponding to the touch electrode SE1 (SE2) and the touch electrode SE3 (SE4). The manner for detecting the short circuit in a touch fan-out line TX3 and a touch fan-out line TX4 is the same as that for detecting the short circuit in the touch fan-out line TX1 and the touch fan-out line TX2, and details are not repeated here.

The difference between FIGS. 5 and 3 is that a display image presented by the touch display panel shown in FIG. 3 indicates that the touch fan-out line TX1 and the touch fan-out line TX2, and the touch fan-out line TX3 and the touch fan-out line TX4 are not short-circuited and that a display image presented by the touch display panel shown in FIG. 5 indicates that the touch fan-out line TX1 and the touch fan-out line TX2 are short-circuited, and the touch fan-out line TX3 and the touch fan-out line TX4 are short-circuited.

In yet another exemplary embodiment, using the touch display panel shown in FIG. 4 as an example, in the touch short-circuit detection stage, the enable levels of the switch control signals can be provided to the first switch control line 601 and the second switch control line 602 so that the control switches 301 can be all turned on. The first common signal line 501 transmits a high-level testing common signal (for example, a voltage of 5 V), and the second common signal line 502 transmits a low-level testing common signal (for example, a voltage of 0 V). Moreover, the first gating control line 401 and the second gating control line 402 both transmit the enable levels of the gating control signals so that gating switches 2011 connected to the first gating control line 401 and the second gating control line 402 transmitting the enable levels can be turned on, and the others gating switches 2011 can be turned off. If the touch fan-out line TX1 corresponding to the touch electrode SE2 and the touch fan-out line TX2 corresponding to the touch electrode SE3 are not short-circuited, the display colors of the pixels corresponding to the touch electrode SE2 and the touch electrode SE3 are white and black respectively. If the touch fan-out line TX1 corresponding to the touch electrode SE2 and the touch fan-out line TX2 corresponding to the touch electrode SE3 are short-circuited, the potentials of the touch electrode SE2 and the touch electrode SE3 are the same and range from 0 V to 5 V, and the display colors of the pixels corresponding to the touch electrode SE2 and the touch electrode SE3 are both gray. Therefore, whether the touch fan-out line TX1 and the touch fan-out line TX2 are short-circuited can be determined by observing the colors of the touch electrode SE2 and the touch electrode SE3. Short-circuit detection can be performed on the other adjacent touch fan-out lines TX in the same manner. For similarities, references can be made to the preceding description, and details are not repeated here.

In other optional embodiments, for the touch display panel shown in FIG. 4, an enable level of a gating control signal may also be provided to one of the first gating control line 401, the second gating control line 402, the third gating control line 403, or the fourth gating control line 404 separately. In this case, whether the touch fan-out line TX1 and the touch fan-out line TX2 are short-circuited can also be determined by observing the display colors of pixels corresponding to the touch electrode SE1 and the touch electrode SE3, or the touch electrode SE2 and the touch electrode SE4, or the touch electrode SE5 and the touch electrode SE7, or the touch electrode SE6 and the touch electrode SE8. Alternatively, in other optional embodiments, enable levels of gating control signals may also be provided to all the first gating control line 401, the second gating control line 402, the third gating control line 403, and the fourth gating control line 404 so that whether the touch fan-out line TX1 and the touch fan-out line TX2 are short-circuited can also be determined by observing the display colors of pixels corresponding to the touch electrode SE1, the touch electrode SE2, the touch electrode SE3, the touch electrode SE4, the touch electrode SE5, the touch electrode SE6, the touch electrode SE7, and the touch electrode SE8. The short-circuit detection can be performed on the other adjacent touch fan-out lines TX in the same manner. For similarities, references can be made to the preceding description, and details are not repeated here.

The short circuit between at least some adjacent touch fan-out lines TX can be detected in the touch short-circuit detection stage through the preceding solutions so that the detection capability of the short circuit in the touch fan-out lines TX can be improved on the basis of meeting the touch performance, thereby improving the reliability of the touch detection.

Additionally, in the touch short-circuit detection stage, if all the gating switches 2011 are controlled to turn off, and testing common signals are provided to the touch electrodes SE in cooperation with the switch control lines 60 and the common signal lines 50, the performance of the touch electrodes SE can be detected according to the display of the pixel corresponding to the touch electrodes SE, thereby ensuring the manufacturing yield of the touch electrodes SE. Exemplarily, enable levels of the switch control signals may be provided to the different switch control lines 60 so that the control switches 301 can be all turned on; the touch electrodes SE in the adjacent touch electrode groups 10 receive different testing common signals so that a black and white checkerboard pattern can be presented in the display region AA. Whether an abnormal touch electrode is present can be determined by the presented black and white checkerboard pattern.

In one or more embodiments, the control switches electrically connected to the adjacent touch electrodes belonging to the different touch electrode groups are connected to the different common signal lines and the different switch control lines respectively. The different testing common signals can be provided to the adjacent touch electrodes belonging to the different touch electrode groups in the touch short-circuit detection stage, and a checkerboard pattern is presented in the display region in units of the touch electrode groups. With this solution, the short circuit in the touch fan-out lines can be determined according to the presented checkerboard pattern, thereby improving the detection capability of the short circuit in the touch fan-out lines and improving the reliability of the touch detection.

The preceding description exemplifies the connection relationship between the two adjacent touch electrodes SE located in the different touch electrode groups 10 and the control switches 301, and the touch detection method. The connection relationship between the touch electrodes SE in the same touch electrode group 10 and the control switches 301 may be designed according to the actual needs, which is not limited in the embodiment of the present disclosure. The technical solutions of the embodiments of the present disclosure are described below in a typical implementation manner.

In one or more embodiments, among touch electrodes SE located in the same row, control switches 301 electrically connected to touch electrodes SE in the same touch electrode group 10 are electrically connected to the same switch control line 60 and the same common signal line 50; and/or among touch electrodes SE located in the same column, control switches 301 electrically connected to touch electrodes SE in the same touch electrode group 10 are electrically connected to the same switch control line 60 and the same common signal line 50.

In an exemplary embodiment, referring to FIG. 3, the touch electrodes SE in the same touch electrode group 10 are arranged along the column direction Y. With this arrangement, in the same touch electrode group 10, the control switches 301 electrically connected to the M (using M equal to 2 as an example) touch electrodes SE arranged along the column direction Y may be electrically connected to the same switch control line 60 to receive a switch control signal transmitted by the same switch control line 60. Moreover, the control switches 301 electrically connected to the M touch electrodes SE arranged along the column direction Y may be electrically connected to the same common signal line 50 to receive a common signal transmitted by the same common signal line 50.

In another exemplary embodiment, referring to FIG. 4, the touch electrodes SE in the same touch electrode group 10 are arranged along the row direction X and the column direction Y respectively. With this arrangement, in the same touch electrode group 10, control switches 301 electrically connected to Q (using Q equal to 2 as an example) touch electrodes SE arranged along the row direction X and P (using P equal to 2 as an example, and Q*P equal to M) touch electrodes SE arranged along the column direction Y may be electrically connected to the same switch control line 60 to receive a switch control signal transmitted by the same switch control line 60. Moreover, the control switches 301 electrically connected to the M touch electrodes SE arranged along the row direction X and the column direction Y may be electrically connected to the same common signal line 50 to receive a common signal transmitted by the same common signal line 50.

In this manner, the control switches 301 electrically connected to the same touch electrode group 10 can be turned on and off at the same time and can transmit the same common signal to the touch electrodes SE. In the touch short-circuit detection stage, if the touch fan-out lines TX are not short-circuited, the pixels corresponding to the M touch electrodes SE in the same touch electrode group 10 all display the same color so that a checkerboard pattern is presented in the display region AA in units of the touch electrode groups 10, thereby meeting the detection requirements of the touch fan-out lines and improving the accuracy of the touch detection.

In one or more embodiments, with continued reference to FIG. 3, among the touch electrodes SE located in the same column, gating switches 2011 electrically connected to the two adjacent touch electrodes SE belonging to the different touch electrode groups 10 are electrically connected to different gating control lines 40 respectively.

In an exemplary embodiment, using the touch electrode SE2 and the touch electrode SE3 in the touch display panel shown in FIG. 3 as an example, the touch electrode SE2 and the touch electrode SE3 are the two touch electrodes SE that are adjacent along the column direction Y and belong to the different touch electrode groups 10. A control terminal of a gating switch 2011 electrically connected to the touch electrode SE2 and a control terminal of a gating switch 2011 electrically connected to the touch electrode SE3 are connected to different gating control lines 40 to receive different gating control signals respectively. For example, the gating switch 2011 electrically connected to the touch electrode SE2 is connected to the second gating control line 402, and the gating switch 2011 electrically connected to the touch electrode SE3 is connected to the first gating control line 401. In this manner, the touch electrodes SE that are adjacent along the column direction Y and belong to the different touch electrode groups 10 can receive touch driving signals in a time-sharing manner and provide testing common signals for the touch detection for touch fan-out lines TX in a time-sharing manner so that the touch detection can be performed on the adjacent touch electrodes SE belonging to the different touch electrode groups 10 in a time-sharing manner.

In the touch display panel shown in FIG. 3, along the row direction X from left to right, among gating switches 2011 electrically connected to the touch electrodes SE located in the same column, gating control lines 40 connected to any two adjacent gating switches 2011 electrically connected to any two adjacent touch electrodes SE are the first gating control line 401 and the second gating control line 402 respectively so that two gating switches 2011 electrically connected to the two adjacent touch electrodes SE belonging to the different touch electrode groups 10 can receive different gating control signals respectively and so that the two gating switches 2011 can be turned on in a time-sharing manner or at the same time, a checkerboard pattern can be presented in the display region in units of the touch electrode groups 10, and the touch detection on the touch electrode groups 10 can be performed according to the presented checkerboard pattern.

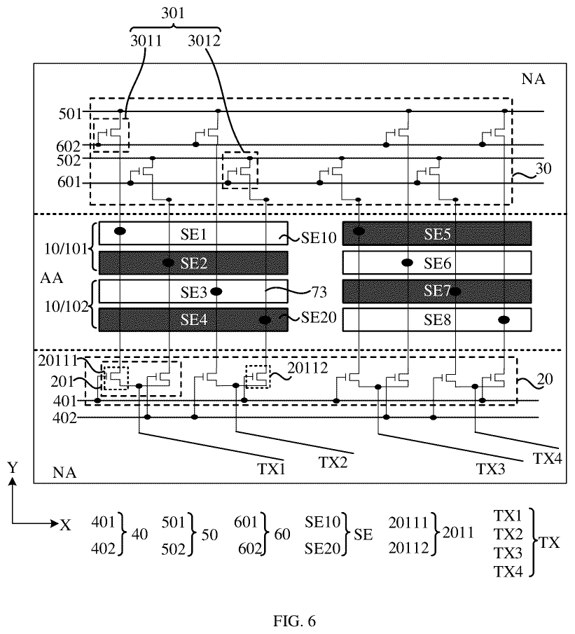

In other optional embodiments, FIG. 6 is still another diagram illustrating the structure of a touch display panel according to one or more embodiments of the present disclosure. Referring to FIG. 6, control switches 301 electrically connected to adjacent touch electrodes SE belonging to the same touch electrode group 10 may be disposed to be electrically connected to different common signal lines 50 respectively.

Exemplarily, as shown in FIG. 6, the same touch electrode group 10 includes two touch electrodes SE arranged along the column direction Y. For example, the touch electrode SE1 and the touch electrode SE2 are two adjacent touch electrodes SE located in the same touch electrode group 10.

Using the touch display panel shown in FIG. 6 as an example, in the same touch electrode group 10, the control switches 301 electrically connected to the two adjacent touch electrodes SE can be connected to the different common signal lines 50 respectively to provide the different common signals for the adjacent touch electrodes SE belonging to the same touch electrode group 10. In this case, one of the two adjacent touch electrodes SE in the same touch electrode group 10 receives a first common signal transmitted by the first common signal line 501, and the other one of the two adjacent touch electrodes SE in the same touch electrode group 10 receives a second common signal transmitted by the second common signal line 502. In this manner, pixels corresponding to the touch electrodes SE in the same touch electrode group 10 present a checkerboard pattern so that the touch detection can be performed on the touch electrodes SE through the checkerboard pattern presented by the pixels.

On the basis that the adjacent touch electrodes SE belonging to the same touch electrode group 10 receive the common signals transmitted by the different common signal lines 50 respectively, the control switches 301 electrically connected to the adjacent touch electrodes SE belonging to the same touch electrode group 10 may be connected to the same switch control line 60 or different switch control lines 60, which is not limited in the embodiment of the present disclosure.

As a feasible embodiment, with continued reference to FIG. 6, the control switches 301 electrically connected to the adjacent touch electrodes SE belonging to the same touch electrode group 10 are electrically connected to the different switch control lines 60 respectively.

In some embodiments, when the control switches 301 electrically connected to the adjacent touch electrodes SE in the same touch electrode group 10 are electrically connected to the different switch control lines 60 respectively, the control switches 301 corresponding to the adjacent touch electrodes SE may be turned on in a time-sharing manner, and the different common signals may be transmitted to the corresponding touch electrodes SE in a time-sharing manner. As shown in FIG. 6, a control terminal of a control switch 301 electrically connected to the touch electrode SE1 is electrically connected to the second switch control line 602, and an input terminal of the control switch 301 electrically connected to the touch electrode SE1 is electrically connected to the first common signal line 501. When a switch control signal transmitted by the second switch control line 602 controls the control switch 301 to turn on, the first common signal (for example, a testing common signal of a high-level signal) transmitted by the first common signal line 501 can be provided to the touch electrode SE1 so that the display color of a pixel corresponding to the touch electrode SE1 can be white. Moreover, a control terminal of a control switch 301 electrically connected to the touch electrode SE2 is electrically connected to the first switch control line 601, and an input terminal of the control switch 301 electrically connected to the touch electrode SE2 is electrically connected to the second common signal line 502. When a switch control signal transmitted by the first switch control line 601 controls the control switch 301 to turn on, the second common signal (for example, a testing common signal of a low-level signal) transmitted by the second common signal line 502 can be provided to the touch electrode SE2 so that the display color of a pixel corresponding to the touch electrode SE2 can be black. In this manner, the pixels corresponding to the two adjacent touch electrodes SE display different colors respectively so that the touch display panel can present a checkerboard pattern, thereby accurately and efficiently detecting a short circuit in the touch fan-out lines through the presented checkerboard pattern of the touch display panel.

In other feasible embodiments, the control switches electrically connected to the adjacent touch electrodes belonging to the same touch electrode group may also be electrically connected to the same switch control line. In this case, the control switches corresponding to the adjacent touch electrodes can be turned on at the same time, and the different common signals can be transmitted to the corresponding touch electrodes at the same time so that the adjacent touch electrodes can also present different display colors respectively, thereby accurately detecting a short circuit in the touch fan-out lines.

In one or more embodiments, with continued reference to FIG. 6, two adjacent touch electrode groups 10 are a first-type touch electrode group 101 and a second-type touch electrode group 102 respectively; one first touch electrode SE10 is present in the first-type touch electrode group 101, and one second touch electrode SE20 is present in the second-type touch electrode group 102; a control switch 301 corresponding to the first touch electrode SE10 and a control switch 301 corresponding to the second touch electrode SE20 are electrically connected to different common signal lines 50; a gating switch 2011 corresponding to the first touch electrode SE10 and a gating switch 2011 corresponding to the second touch electrode SE20 are electrically connected to the same gating control line 40.

As shown in FIG. 6, of the two adjacent touch electrode groups 10 arranged along the column direction Y, one is the first-type touch electrode group 101, and the other one is the second-type touch electrode group 102. The first-type touch electrode group 101 includes at least one first touch electrode SE10, and the second-type touch electrode group 102 includes at least one second touch electrode SE20. In other words, the first touch electrode SE10 and the second touch electrode SE20 belong to the two adjacent touch electrode groups 10 respectively.

The control switches 301 electrically connected to the first touch electrode SE10 and the second touch electrode SE20 are electrically connected to different switch control lines 60 respectively, and the gating switches 2011 electrically connected to the first touch electrode SE10 and the second touch electrode SE20 are connected to the same gating control line 40. The control switch 301 corresponding to the first touch electrode SE10 may be defined as a first control switch 3011, and the gating switch 2011 corresponding to the first touch electrode SE10 may be defined as a first gating switch 20111; the control switch 301 corresponding to the second touch electrode SE20 may be defined as a second control switch 3012, and the gating switch 2011 corresponding to the second touch electrode SE20 may be defined as a second gating switch 20112. Input terminals of the first control switch 3011 and the second control switch 3012 may be electrically connected to the first common signal line 501 and the second common signal line 502 respectively. Control terminals of the first gating switch 20111 and the second gating switch 20112 may be connected to the same gating control line 40. In FIG. 6, the first gating switch 20111 and the second gating switch 20112 being both connected to the first gating control line 401 is used as an example, which is not actually limited thereto. Additionally, control terminals of the first control switch 3011 and the second control switch 3012 may also be disposed to be connected to the second switch control line 602 and the first switch control line 601 respectively, and first terminals of the first gating switch 20111 and the second gating switch 20112 are connected to different touch fan-out lines TX respectively.

With this configuration, the first touch electrode SE10 and the second touch electrode SE20 that correspond to the different gating switches 2011 controlled by a gating control signal transmitted by the same gating control line 40 may receive different common signals. In the touch short-circuit detection stage, the first gating switch 20111 and the second gating switch 20112 may be controlled to turn on, and the first control switch 3011 and the second control switch 3012 may be controlled to turn on, so as to transmit the first common signal and the second common signal to the first touch electrode SE10 and the second touch electrode SE20. According to the display colors of pixels corresponding to the first touch electrode SE10 and the second touch electrode SE20, whether the touch fan-out lines TX corresponding to the first gating switch 20111 and the second gating switch 20112 respectively are short-circuited can be detected.

Exemplarily, referring to FIG. 6, using the two adjacent touch electrode groups 10 along the column direction Y being the first-type touch electrode group 101 and the second-type touch electrode group 102 as an example, control switches 301 corresponding to the touch electrode SE1 and the touch electrode SE4 are connected to the first common signal line 501 and the second common signal line 502 respectively, and gating switches 2011 corresponding to the touch electrode SE1 and the touch electrode SE4 are connected to the first gating control line 401; control switches 301 corresponding to the touch electrode SE2 and the touch electrode SE3 are connected to the second common signal line 502 and the first common signal line 501 respectively, and gating switches 2011 corresponding to the touch electrode SE2 and the touch electrode SE3 are connected to the second gating control line 402. In this case, the touch electrode SE1 and the touch electrode SE2 may both be first touch electrodes SE10, and the touch electrode SE4 and the touch electrode SE3 may both be second touch electrodes SE20. FIG. 6 exemplarily shows that the touch electrode SE1 is the first touch electrode SE10 and that the touch electrode SE4 is the second touch electrode SE20, which is not actually limited thereto and may be designed according to the actual needs. Details are not repeated here.

With continued reference to FIG. 6, control terminals of the gating switches 201 corresponding to the touch electrode SE2 and the touch electrode SE3 that are adjacent but belong to the different touch electrode groups 10 are electrically connected to the same second gating control line 402, and control terminals of the gating switches 201 corresponding to the touch electrode SE1 and the touch electrode SE4 that belong to the different touch electrode groups 10 are electrically connected to the same first gating control line 401. In this case, the gating switches 201 electrically connected to the touch electrode SE2 and the touch electrode SE3 may be turned on at the same time, and the gating switches 201 electrically connected to the touch electrode SE1 and the touch electrode SE4 may be turned on at the same time.

Using FIG. 6 as an example, in the touch short-circuit detection stage, enable levels of the switch control signals may be provided to the first switch control line 601 and the second switch control line 602, so the control switches 301 are all turned on. The first common signal line 501 transmits the high-level testing common signal (for example, the voltage of 5 V), and the second common signal line 502 transmits the low-level testing common signal (for example, the voltage of 0 V). Moreover, the enable level of the gating control signal may be provided to the first gating control line 401, so gating switches 2011 connected to the first gating control line 401 are turned on. If the touch fan-out line TX1 corresponding to the touch electrode SE1 and the touch fan-out line TX2 corresponding to the touch electrode SE4 are not short-circuited respectively, the display colors of pixels corresponding to the touch electrode SE1 and the touch electrode SE4 are white and black respectively. If the touch fan-out line TX1 corresponding to the touch electrode SE1 and the touch fan-out line TX2 corresponding to the touch electrode SE4 are short-circuited, the potentials of the touch electrode SE1 and the touch electrode SE4 are the same and range from 0 V to 5 V, and the display colors of the pixels corresponding to the touch electrode SE1 and the touch electrode SE4 are both gray. Therefore, whether the touch fan-out line TX1 and the touch fan-out line TX2 are short-circuited can be determined by observing the display colors of the pixels corresponding to the touch electrode SE1 and the touch electrode SE4. Accordingly, when the enable level of the gating control signal is provided to the second gating control line 402, whether the touch fan-out line TX1 and the touch fan-out line TX2 are short-circuited can be determined by observing the display colors of the pixels corresponding to the touch electrode SE2 and the touch electrode SE3. The specific principle is similar to the preceding and is not repeated here. Similarly, the short-circuit detection may be performed in the other adjacent touch fan-out lines TX. In this manner, the short circuit between most adjacent touch fan-out lines TX in the touch display panel can be detected to increase the reliability of the touch detection.

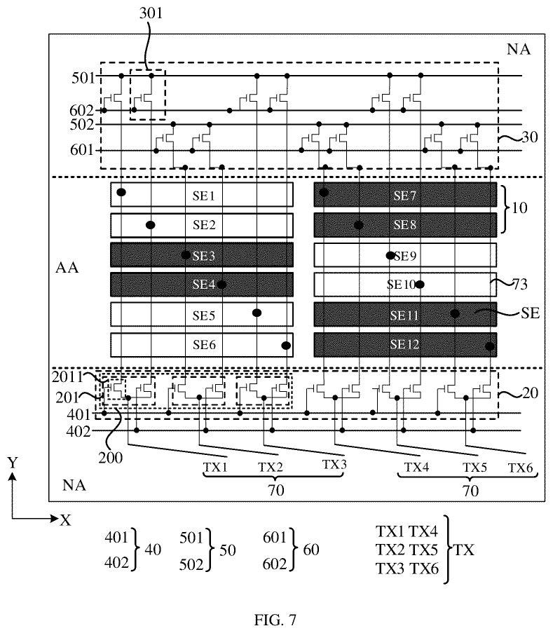

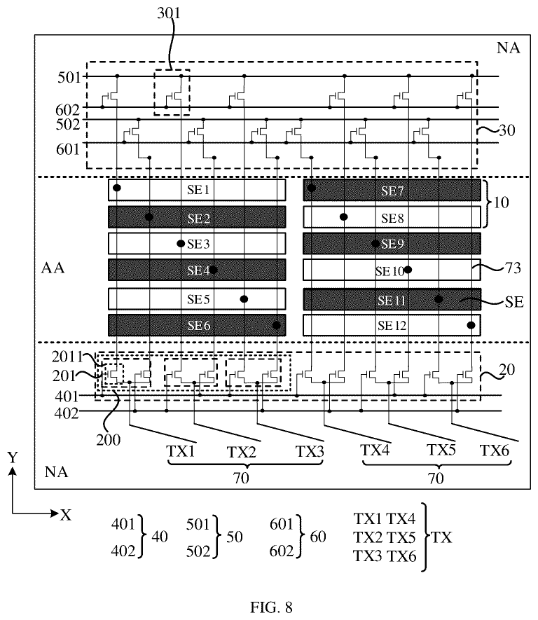

An even number (specifically, for example, two) of touch electrode groups 10 arranged in the same column direction Y is used as an example for description in the preceding embodiments. FIG. 7 is still another diagram illustrating the structure of a touch display panel according to one or more embodiments of the present disclosure. FIG. 8 is still another diagram illustrating the structure of a touch display panel according to one or more embodiments of the present disclosure. Referring to FIGS. 7 and 8, in other possible embodiments, an odd number of touch electrode groups 10 may be arranged in the same column direction Y, and the figures including three touch electrode groups 10 is used as an example for description, which is not limited thereto.

In the touch display panel shown in FIGS. 7 and 8, in the touch short-circuit detection stage, the short circuit in at least some adjacent touch fan-out lines TX (such as the touch fan-out line TX1 and the touch fan-out line TX2, the touch fan-out line TX2 and the touch fan-out line TX3, the touch fan-out line TX4 and the touch fan-out line TX5, or the touch fan-out line TX5 and the touch fan-out line TX6) may also be detected according to the checkerboard pattern presented in the display region AA. The specific detection solution is the same as the detection solution described in the preceding embodiments and is not described in detail here.

In one or more embodiments, with continued reference to FIGS. 7 and 8, multi-channel gating circuits 201 electrically connected to touch electrode groups 10 located in the same column form a multi-channel gating circuit group 200; in the same multi-channel gating circuit group 200, a multi-channel gating circuit 201 electrically connected to a touch electrode group 10 located in the i-th row is an i-th multi-channel gating circuit 201; the number of touch electrode groups 10 located in the same column is N, 1≤i≤N, and i and N are both positive integers; along the row direction X of the touch electrodes, the touch fan-out lines TX are arranged sequentially; N adjacent touch fan-out lines TX form a touch fan-out line group 70; the touch fan-out lines TX in the same touch fan-out line group 70 are electrically connected to the multi-channel gating circuits 201 in the same multi-channel gating circuit group 200 respectively; the arrangement number of the touch fan-out lines TX in the touch fan-out line group 70 is the same as the arrangement number of the multi-channel gating circuits 201 in the multi-channel gating circuit group 200 that are correspondingly electrically connected to the touch fan-out line group 70, that is, in any touch fan-out line group 70 and multiple selection circuit group 200 that are correspondingly electrically connected, an n-th multi-channel gating circuit 201 in the multiple selection circuit group 200 is electrically connected to an n-th touch fan-out line TX in the fan-out line group 70, where 1≤n<N, and n is an integer.

In some embodiments, as shown in FIGS. 7 and 8, the same multi-channel gating circuit group 200 may include N multi-channel gating circuits 201; the N multi-channel gating circuits 201 may be arranged along the row direction X and are connected to multiple touch electrode groups 10 arranged along the column direction Y in one-to-one correspondence. That is, the number of touch electrode groups 10 located in the same column may be the same as the number of multi-channel gating circuits 201 in the same multi-channel gating circuit group 200; touch electrodes SE in a touch electrode group 10 located in the n-th row may be electrically connected to a multi-channel gating circuit 201 with the serial number of n in the same multi-channel gating circuit group 200. For example, a touch electrode group 10 located in the j-th column and the i-th row may be electrically connected to an i-th multi-channel gating circuit 201 in a j-th multi-channel gating circuit group 200. When one touch electrode group 10 includes two touch electrodes SE arranged along the column direction Y, the two touch electrodes SE in the touch electrode group 10 located in the i-th row are electrically connected to two gating switches 2011 in the i-th multi-channel gating circuit 201 respectively.

FIGS. 7 and 8 exemplarily show three rows and two columns of touch electrode groups 10, the left side is a first column of touch electrode groups 10 and the right side is a second column of touch electrode groups 10, and touch electrodes SE in the first column of touch electrode groups 10 are electrically connected to a first multi-channel gating circuit group 200. In the first column of touch electrode groups 10, a first row of touch electrode group 10 is electrically connected to a first multi-channel gating circuit 201 in the first multi-channel gating circuit group 200 (the multi-channel gating circuit 201 with the serial number of 1 in the multi-channel gating circuit group 200), a second row of touch electrode group 10 is electrically connected to a second multi-channel gating circuit 201 in the first multi-channel gating circuit group 200 (the multi-channel gating circuit 201 with the serial number of 2 in the multi-channel gating circuit group 200), and a third row of touch electrode group 10 is electrically connected to a third multi-channel gating circuit 201 in the first multi-channel gating circuit group 200 (the multi-channel gating circuit 201 with the serial number of 3 in the multi-channel gating circuit group 200). The connection relationship between the second column of touch electrode groups 10 and a second multi-channel gating circuit group 200 is similar.

The difference between FIGS. 7 and 8 is the connection mode of gating switches 2011 in two adjacent multi-channel gating circuits 201. Exemplarily, in the touch display panel shown in FIG. 7, adjacent gating switches 2011 belonging to different multi-channel gating circuits 201 are electrically connected to different gating control lines 40 respectively; for example, in the same multi-channel gating circuit group 200, a second gating switch 2011 (the gating switch 2011 with the serial number of 2) in the first multi-channel gating circuit 201 is electrically connected to the second gating control line 402, and a first gating switch 2011 (the gating switch 2011 with the serial number of 1) in the second multi-channel gating circuit 201 is electrically connected to the first gating control line 401. In the touch display panel shown in FIG. 8, in the same multi-channel gating circuit group 200, adjacent gating switches 2011 belonging to different multi-channel gating circuits 201 are electrically connected to the same gating control line 40, and adjacent gating switches 2011 in the same multi-channel gating circuit 201 are electrically connected to different gating control lines 40 respectively. For example, in the same multi-channel gating circuit group 200, the second gating switch 2011 in the first multi-channel gating circuit 201 and the first gating switch 2011 in the second multi-channel gating circuit 201 are both electrically connected to the second gating control line 402; the last gating switch 2011 in the first multi-channel gating circuit group 200 is electrically connected to the second gating control line 402, and the first gating switch 2011 in the second multi-channel gating circuit group 200 is electrically connected to the first gating control line 401.

With continued reference to FIGS. 7 and 8, the N touch fan-out lines TX electrically connected to the N multi-channel gating circuits 201 in the same multi-channel gating circuit group 200 form one touch fan-out line group 70. The N touch fan-out lines TX in the same touch fan-out line group 70 are electrically connected to the N multi-channel gating circuits 201 in the same multi-channel gating circuit group 200 respectively. For example, three touch fan-out lines TX connected to three multi-channel gating circuits 201 in the same multi-channel gating circuit group 200 form one touch fan-out line group 70.

Exemplarily, in the touch display panel shown in FIGS. 7 and 8, in the touch short-circuit detection stage, the enable levels of the switch control signals can be provided to the first switch control line 601 and the second switch control line 602 so that the control switches 301 can be all turned on. The first common signal line 501 transmits the high-level testing common signal (for example, the voltage of 5 V), and the second common signal line 502 transmits the low-level testing common signal (for example, the voltage of 0 V). Moreover, the enable level of the gating control signal may be provided to the first gating control line 401, so the gating switches 2011 connected to the first gating control line 401 are turned on, and the other gating switches 2011 are turned off.

As shown in FIG. 7, the short-circuit detection in any two adjacent touch fan-out lines TX in the same touch fan-out line group 70 is performed in the following manner. Using the touch fan-out line TX2 and the touch fan-out line TX3 that are adjacent in a first touch fan-out line group 70 on the left side as an example, if the touch fan-out line TX2 and the touch fan-out line TX3 are not short-circuited, the touch electrode SE3 receives a voltage of 0 V, the touch electrode SE5 receives a voltage of 5 V, and display colors of the pixels corresponding to the touch electrode SE3 and the touch electrode SE5 are black and white respectively; if the touch fan-out line TX2 and the touch fan-out line TX3 are short-circuited, the potentials of the touch electrode SE3 and the touch electrode SE5 each range from 0 V to 5 V, and display colors of the pixels corresponding to the touch electrode SE3 and the touch electrode SE5 are both gray. Therefore, whether any two adjacent touch fan-out lines TX in the same touch fan-out line group 70 are short-circuited can be determined through a pattern presented in the display region. The short-circuit detection for two adjacent touch fan-out lines TX belonging to different touch fan-out line groups 70 is performed in the following manner. If the touch fan-out line TX3 and the touch fan-out line TX4 are short-circuited, the potentials of the touch electrode SE5 and the touch electrode SE7 each range from 0 V to 5 V, and the display colors of the pixels corresponding to the touch electrode SE5 and the touch electrode SE7 are both gray. The short-circuit detection is similarly performed in adjacent touch fan-out lines TX in the touch display panel shown in FIG. 8.

In the embodiments shown in FIGS. 7 and 8, an odd number of touch electrode groups 10 are arranged in the same column direction Y, and multiple multi-channel gating circuits 201 arranged along the row direction X are electrically connected to multiple touch fan-out lines TX arranged along the row direction X in one-to-one correspondence. There is no need to exchange the connection relationship between the touch fan-out lines TX and the multiple multi-channel gating circuits 201, and the short circuit in any two adjacent touch fan-out lines TX may be detected by observing a checkerboard pattern presented in the display region of the touch display panel.

With continued reference to FIGS. 3 and 6, an even number of touch electrode groups 10 are arranged in the same column direction Y, and the multiple multi-channel gating circuits 201 arranged along the row direction X are electrically connected to the multiple touch fan-out lines TX arranged along the row direction X in one-to-one correspondence, that is, along the direction from left to right as shown in the figures, the i-th multi-channel gating circuit 201 is electrically connected to an i-th touch fan-out line TX. With this arrangement, the touch fan-out line TX is close to a gating switch 2011 electrically connected to the touch fan-out line TX, which is conducive to a reduction in the wiring difficulty. However, when short-circuit detection is performed, since touch electrodes SE electrically connected to two adjacent touch fan-out lines TX located in the different touch fan-out line groups 70 receives the same common signal, the short circuit in the two adjacent touch fan-out lines TX located in the different touch fan-out line groups 70 cannot be detected.

In some embodiments, in the touch short-circuit detection stage, the enable levels are transmitted to the first switch control line 601 and the second switch control line 602 to enable the control switches 301 all to be turned on. The first common signal line 501 transmits a high-level signal (for example, a voltage of 5 V), and the second common signal line 502 transmits a low-level signal (for example, a voltage of 0 V). Moreover, the gating switches 2011 connected to the first gating control line 401 are controlled to turn on. Referring to FIG. 3, the touch fan-out line TX2 is electrically connected to the touch electrode SE3 and the touch electrode SE4 through a multi-channel gating circuit 201, the touch fan-out line TX3 is electrically connected to the touch electrode SE5 and the touch electrode SE6 through a multi-channel gating circuit 201, and the touch fan-out line TX4 is electrically connected to the touch electrode SE7 and the touch electrode SE8 through a multi-channel gating circuit 201. When the first gating control line 401 (or the second gating control line 402) provides an enable level, the gating switches 2011 corresponding to the touch electrode SE3 and the touch electrode SE5 (or the touch electrode SE4 and the touch electrode SE6) are turned on. If the adjacent touch fan-out line TX2 and touch fan-out line TX3 are short-circuited, the touch electrode SE3 and the touch electrode SE5 (or the touch electrode SE4 and the touch electrode SE6) are connected to form a loop. Since the touch electrode SE3 and the touch electrode SE5 (or the touch electrode SE4 and the touch electrode SE6) both receive a voltage of 0 V, regardless of whether the touch fan-out line TX2 and the touch fan-out line TX3 are short-circuited or not, the display colors of the touch electrode SE3 and the touch electrode SE5 (or the touch electrode SE4 and the touch electrode SE6) are black, so whether the touch fan-out line TX2 and the touch fan-out line TX3 are short-circuited cannot be determined based on a checkerboard pattern. Referring to FIG. 6, when the first gating control line 401 (or the second gating control line 402) transmits the enable level, gating switches 2011 corresponding to the touch electrode SE4 and the touch electrode SE5 (or the touch electrode SE3 and the touch electrode SE6) are turned on. If the adjacent touch fan-out line TX2 and touch fan-out line TX3 are short-circuited, the touch electrode SE4 and the touch electrode SE5 (or the touch electrode SE3 and the touch electrode SE6) are connected to form a loop. Since the touch electrode SE4 and the touch electrode SE5 (or the touch electrode SE3 and the touch electrode SE6) both receive a voltage of 0 V (a voltage of 5 V), regardless of whether the touch fan-out line TX2 and the touch fan-out line TX3 are short-circuited or not, the display colors of the touch electrode SE4 and the touch electrode SE5 (or the touch electrode SE3 and the touch electrode SE6) are both black (or white), so whether the touch fan-out line TX2 and the touch fan-out line TX3 are short-circuited cannot be determined based on a checkerboard pattern. Based on the preceding problems, the present disclosure further provides the following optional embodiments.

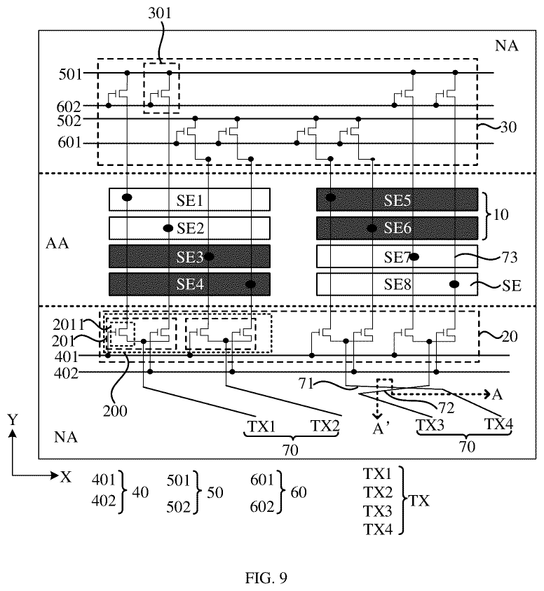

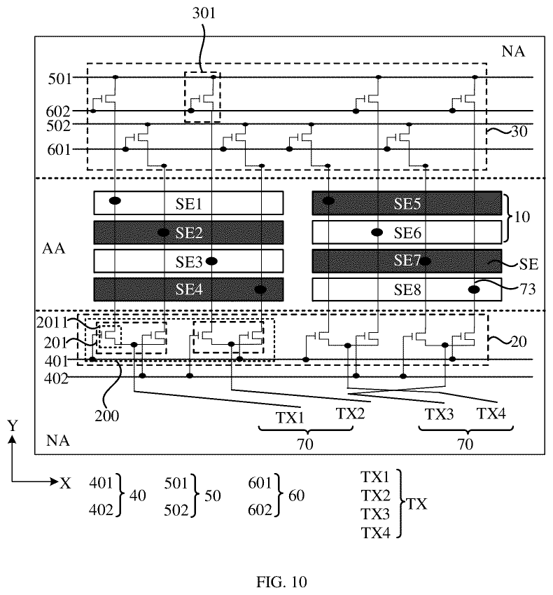

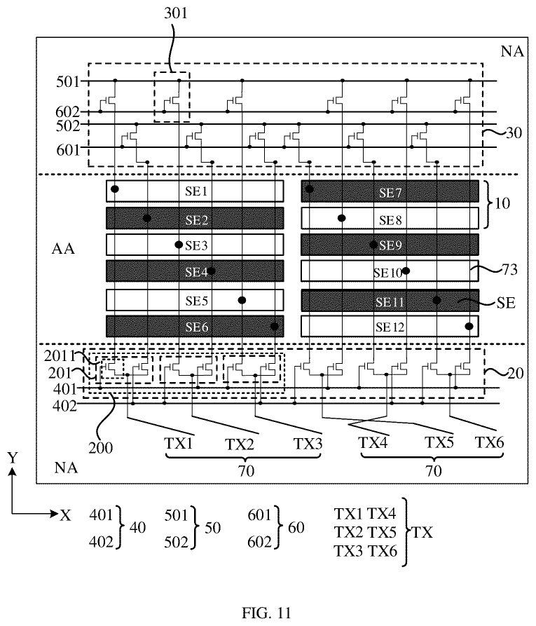

In one or more embodiments, FIG. 9 is still another diagram illustrating the structure of a touch display panel according to one or more embodiments of the present disclosure; FIG. 10 is still another diagram illustrating the structure of a touch display panel according to one or more embodiments of the present disclosure; FIG. 11 is still another diagram illustrating the structure of a touch display panel according to one or more embodiments of the present disclosure. In some embodiments, referring to FIGS. 9 and 10, the multi-channel gating circuits 201 electrically connected to the touch electrode groups 10 located in the same column form the multi-channel gating circuit group 200; in the same multi-channel gating circuit group 200, the i-th multi-channel gating circuit 201 is electrically connected to the touch electrode group 10 located in the i-th row; when the number of touch electrode groups 10 located in the same column is N, 1≤i≤N, i and N are both positive integers; along the row direction X of the touch electrodes SE, the touch fan-out lines TX are arranged sequentially; the N adjacent touch fan-out lines TX form the touch fan-out line group 70; the touch fan-out lines TX in the same touch fan-out line group 70 are electrically connected to the multi-channel gating circuits 201 in the same multi-channel gating circuit group 200 respectively; the two adjacent touch fan-out lines TX belonging to different touch fan-out line groups 70 are electrically connected to an s-th multi-channel gating circuit 201 and a k-th multi-channel gating circuit 201 respectively; 1≤s≤N, 1≤k≤N, and s and k are both even numbers or odd numbers, that is, the two adjacent touch fan-out lines TX belonging to the different touch fan-out line groups 70 are electrically connected to multi-channel gating circuits 201 with odd serial numbers or multi-channel gating circuits 201 with even serial numbers respectively.

In some embodiments, with continued reference to FIGS. 9 and 10, two adjacent touch fan-out lines TX in adjacent touch fan-out line groups 70 may be electrically connected to two multi-channel gating circuits 201 spaced apart. For example, as shown in FIG. 9, the two adjacent touch fan-out lines TX belonging to the different touch fan-out line groups 70 are the touch fan-out line TX2 and the touch fan-out line TX3 respectively, the touch fan-out line TX2 is electrically connected to touch electrodes SE through the second multi-channel gating circuit 201 in the first multi-channel gating circuit group 200, and the touch fan-out line TX3 is electrically connected to touch electrodes SE through a second multi-channel gating circuit 201 in the second multi-channel gating circuit group 200. In the embodiment shown in FIG. 10, the touch fan-out line TX2 and the touch fan-out line TX3 are connected to multi-channel gating circuits 201 in the same manner. With this arrangement, two touch fan-out lines TX in a second touch fan-out line group 70 cross each other and are connected to different multi-channel gating circuits 201.

Additionally, in touch electrode groups 10 electrically connected to any two adjacent touch fan-out lines TX, different touch electrodes SE electrically connected to the same gating control line 40 receive different common signals. Exemplarily, as shown in FIG. 9, the touch electrode SE3 (or the touch electrode SE4) connected to the touch fan-out line TX2 and the touch electrode SE7 (or the touch electrode SE8) connected to the touch fan-out line TX3 are electrically connected to different common signal lines 50 through control switches 301 respectively. Alternatively, as shown in FIG. 10, the touch electrode SE3 (or the touch electrode SE4) connected to the touch fan-out line TX2 and the touch electrode SE7 (or the touch electrode SE8) connected to the touch fan-out line TX3 are electrically connected to different common signal lines 50 through control switches 301 respectively.

The difference between the embodiments of FIGS. 9 and 10 is that in the embodiment shown in FIG. 9, the connection mode between the touch electrode groups 10 and the control switches 301, the switch control lines 50, the common signal lines 60, the multi-channel gating circuits 201, and the gating control lines 40 is the same as that in the embodiment shown in FIG. 3; in the embodiment shown in FIG. 10, the connection mode between the touch electrode groups 10 and the control switches 301, the switch control lines 50, the common signal lines 60, the multi-channel gating circuits 201, and the gating control lines 40 is the same as that in the embodiment shown in FIG. 6.

In an exemplary embodiment, as shown in FIG. 9, taking each column including two touch electrode groups 10, each multi-channel gating circuit group 200 including two multi-channel gating circuits 201, and each touch fan-out line group 70 including two touch fan-out lines TX as an example, the second multi-channel gating circuit 201 with the serial number of 2 in the second multi-channel gating circuit group 200 is electrically connected to a first touch fan-out line TX3 with the serial number of 1 in the second touch fan-out line group 70, and the first multi-channel gating circuit 201 with the serial number of 1 in the second multi-channel gating circuit group 200 is electrically connected to a second touch fan-out line TX4 with the serial number of 2 in the second touch fan-out line group 70. The touch fan-out line TX3 is electrically connected to the touch electrode SE7 and the touch electrode SE8 through the multi-channel gating circuit 201, and the touch fan-out line TX4 is electrically connected to the touch electrode SE5 and the touch electrode SE6 through the multi-channel gating circuit 201. In the touch short-circuit detection stage, when the first gating control line 401 (and/or the second gating control line 402) transmits the enable level of the gating control signal, gating switches 2011 corresponding to the touch electrode SE3 and the touch electrode SE7 (and/or the touch electrode SE4 and the touch electrode SE8) are turned on. If the adjacent touch fan-out line TX2 and touch fan-out line TX3 are short-circuited, the touch electrode SE3 and the touch electrode SE7 (and/or the touch electrode SE4 and the touch electrode SE8) are connected to form a loop. Since the touch electrode SE3 and the touch electrode SE7 (and/or the touch electrode SE4 and the touch electrode SE8) receive different testing common signals respectively, for example, a voltage of 0 V and a voltage of 5 V (or a voltage of 5 V and a voltage of 0 V) respectively, when the touch fan-out line TX2 and the touch fan-out line TX3 are short-circuited, the display colors of pixels corresponding to the touch electrode SE3 and the touch electrode SE7 (and/or the touch electrode SE4 and the touch electrode SE8) are gray. In this case, whether the touch fan-out line TX2 and the touch fan-out line TX3 are short-circuited can be determined according to the presented checkerboard pattern.

In another exemplary embodiment, as shown in FIG. 11, the same column direction Y includes an odd number (using three in the figure as an example) of touch electrode groups 10. Different from the embodiment shown in FIG. 8, in this embodiment, two adjacent gating switches 2011 in two adjacent multi-channel gating circuit groups 200 are electrically connected to the same gating control line 40. For example, the last gating switch 2011 in the first multi-channel gating circuit group 200 and the first gating switch 2011 in the second multi-channel gating circuit group 200 are both electrically connected to the second gating control line 402.

Based on the preceding connection mode between the gating switches 2011 and the gating control lines 40, in the embodiment shown in FIG. 11, to perform the short-circuit detection on adjacent touch fan-out lines TX belonging to different touch fan-out line groups 70, it needs to exchange the connection relationship between some adjacent touch fan-out lines TX and the different multi-channel gating circuits 201.

Exemplarily, as shown in FIG. 11, the two adjacent touch fan-out lines TX belonging to the different touch fan-out line groups 70 are the touch fan-out line TX3 and the touch fan-out line TX4 respectively, the touch fan-out line TX3 is electrically connected to touch electrodes SE through a third multi-channel gating circuit 201 in the first multi-channel gating circuit group 200, and the touch fan-out line TX4 is electrically connected to touch electrodes SE through the second multi-channel gating circuit 201 in the second multi-channel gating circuit group 200. Similarly, two adjacent touch fan-out lines TX in adjacent touch fan-out line groups 70 are electrically connected to two multi-channel gating circuits 201 spaced apart. In this manner, a first touch fan-out line TX4 and a second touch fan-out line TX5 in the second touch fan-out line group 70 cross each other and are connected to different multi-channel gating circuits 201 respectively.

The short-circuit detection in the touch fan-out line TX3 and the touch fan-out line TX4 is performed in the following manner. In the touch short-circuit detection stage, the enable levels are transmitted to the first switch control line 601 and the second switch control line 602, so the control switches 301 are all turned on. The first common signal line 501 transmits a voltage of 5 V, and the second common signal line 502 transmits a voltage of 0 V. The enable level is transmitted to the first gating control line 401, so the gating switches 2011 connected to the first gating control line 401 are turned on. Control switches 301 corresponding to the touch electrode SE5 and the touch electrode SE9 transmit a voltage of 5 V and a voltage of 0 V respectively. If the touch fan-out line TX3 and the touch fan-out line TX4 are not short-circuited, display colors of the pixels corresponding to the touch electrode SE5 and the touch electrode SE9 are white and black respectively; if the touch fan-out line TX3 and the touch fan-out line TX4 are short-circuited, the touch electrode SE5 and the touch electrode SE9 form a loop, the potentials of the touch electrode SE5 and the touch electrode SE9 are the same and range from 0 V to 5 V, and display colors of the pixels corresponding to the touch electrode SE5 and the touch electrode SE9 are both gray. Therefore, whether the touch fan-out line TX3 and the touch fan-out line TX4 are short-circuited can be determined according to the presented checkerboard pattern.

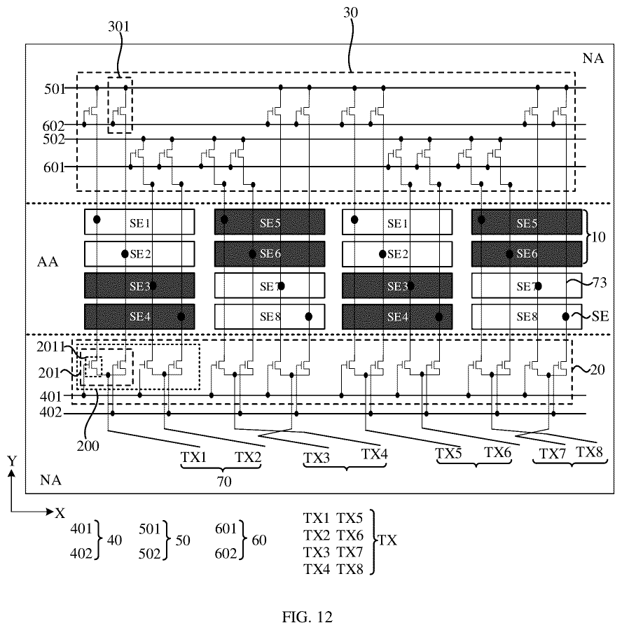

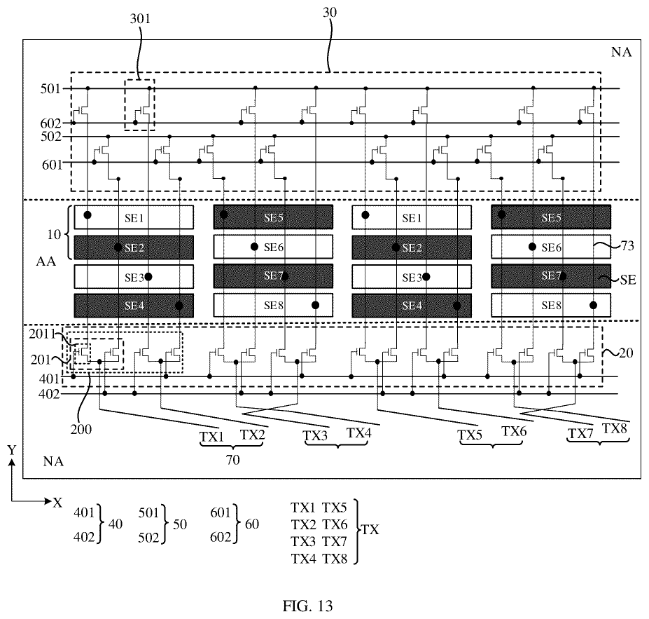

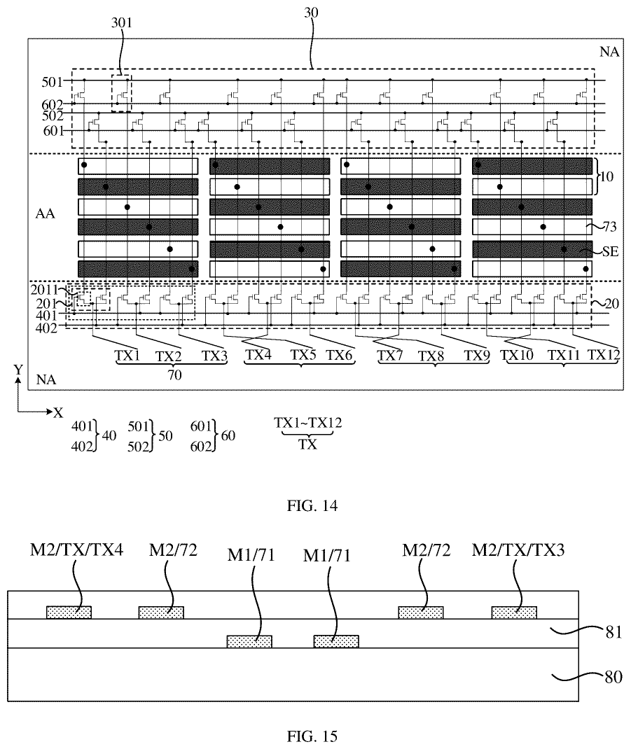

In one or more embodiments, FIG. 12 is still another diagram illustrating the structure of a touch display panel according to one or more embodiments of the present disclosure; FIG. 13 is still another diagram illustrating the structure of a touch display panel according to one or more embodiments of the present disclosure; FIG. 14 is still another diagram illustrating the structure of a touch display panel according to one or more embodiments of the present disclosure. In some embodiments, referring to FIGS. 12 and 13, when N is an even number, in a multi-channel gating circuit group 200 corresponding to touch electrode groups 10 located in the j-th column, an m-th multi-channel gating circuit 201 is electrically connected to a touch fan-out line TX with the serial number of m+1 in a j-th touch fan-out line group 70, and an (m+1)-th multi-channel gating circuit 201 is electrically connected to a touch fan-out line TX with the serial number of m in the j-th touch fan-out line group 70; 1<m<N, m is an odd number, and j is an even number. In some other embodiments, referring to FIG. 14, when N is an odd number, in the multi-channel gating circuit group 200 corresponding to the touch electrode groups 10 located in the j-th column, the m-th multi-channel gating circuit 201 is electrically connected to the touch fan-out line TX with the serial number of m+1 in the j-th touch fan-out line group 70, and the (m+1)-th multi-channel gating circuit 201 is electrically connected to the touch fan-out line TX with the serial number of m in the j-th touch fan-out line group 70; 1≤m<N, m is an odd number, and j is a positive integer greater than 1.

As a feasible embodiment, FIGS. 9, 10, 12, and 13 show the case where N is an even number. In this case, the touch electrode groups 10 located in the j-th column may be electrically connected to the j-th touch fan-out line group 70 through a j-th multi-channel gating circuit group 200. The touch electrode groups 10 located in the j-th column may be referred to as any touch electrode groups 10 located in an even-numbered column, the j-th multi-channel gating circuit group 200 may be referred to as any even-numbered multi-channel gating circuit group 200, and the j-th touch fan-out line group 70 may be referred to as any even-numbered touch fan-out line group 70. In this embodiment, in an even-numbered multi-channel gating circuit group 200, a multi-channel gating circuit 201 with an odd serial number may be electrically connected to a touch fan-out line TX with an even serial number, that is, adjacent touch fan-out lines TX in any even-numbered touch fan-out line group 70 cross each other and are connected to different multi-channel gating circuits 201 respectively. Touch fan-out lines TX in an odd-numbered touch fan-out line group 70 are connected to multi-channel gating circuits 201 in an odd-numbered multi-channel gating circuit group 200 in one-to-one correspondence according to the serial numbers.

Exemplarily, as shown in FIG. 12, the first multi-channel gating circuit 201 in the second multi-channel gating circuit group 200 is electrically connected to the second touch fan-out line TX4 in the second touch fan-out line group 70, and the second multi-channel gating circuit 201 in the second multi-channel gating circuit group 200 is electrically connected to the first touch fan-out line TX3 in the second touch fan-out line group 70. A first multi-channel gating circuit 201 in a fourth multi-channel gating circuit group 200 is electrically connected to a second touch fan-out line TX8 in a fourth touch fan-out line group 70, and a second multi-channel gating circuit 201 in the fourth multi-channel gating circuit group 200 is electrically connected to a first touch fan-out line TX7 in the fourth touch fan-out line group 70. In this manner, the touch fan-out lines TX in the even-numbered touch fan-out line group 70 cross each other to ensure that the short circuit in any adjacent touch fan-out lines TX can be accurately detected, further improving the reliability of the touch detection. The same holds true for the embodiment shown in FIG. 13, and details are not repeated here.

As another feasible embodiment, FIG. 14 shows the case where N is an odd number. When the same column includes an odd number of touch electrode groups 10, the touch electrode group 10 located in the j-th column may be referred to as a touch electrode group 10 located in any column other than a touch electrode group 10 located in a first column, the j-th multi-channel gating circuit group 200 may be referred to as any multi-channel gating circuit group 200 other than the first multi-channel gating circuit group 200, and the j-th touch fan-out line group 70 may be referred to as any touch fan-out line group 70 other than the first touch fan-out line group 70. In this embodiment, in any multi-channel gating circuit group 200 other than the first multi-channel gating circuit group 200, a multi-channel gating circuit 201 with an odd serial number may be electrically connected to a touch fan-out line TX with an even serial number, that is, two adjacent touch fan-out lines TX in any touch fan-out line group 70 other than the first touch fan-out line group 70 cross each other and are connected to different multi-channel gating circuits respectively.

Exemplarily, as shown in FIG. 14, the first multi-channel gating circuit 201 in the second multi-channel gating circuit group 200 is electrically connected to the second touch fan-out line TX5 in the second touch fan-out line group 70, and the second multi-channel gating circuit 201 in the second multi-channel gating circuit group 200 is electrically connected to the first touch fan-out line TX4 in the second touch fan-out line group 70. Similarly, two adjacent touch fan-out lines TX in each subsequent touch fan-out line group 70 cross each other and are connected to different multi-channel gating circuits 201 respectively, thereby exchanging the connection relationship between the multi-channel gating circuits 201 and the adjacent touch fan-out lines in any touch fan-out line group 70 other than the first touch fan-out line group 70 to increase the reliability of the touch detection.

When the two adjacent touch fan-out lines cross each other and are connected to the different multi-channel gating circuits, corresponding signal lines are required to exchange the connected multi-channel gating circuits when the two touch fan-out lines are connected to the multi-channel gating circuits to prevent signals transmitted by the two touch fan-out lines from interfering with each other. The specific implementation manner may be designed according to the actual needs, which is not limited in the embodiment of the present disclosure.

In one or more embodiments, FIG. 15 is a cross-sectional diagram of FIG. 9 taken along an A-A′ direction. In conjunction with reference to FIGS. 9 and 15, the non-display region NA of the touch display panel also includes multiple first connection lines 71 and multiple second connection lines 72 that are insulated from each other; the m-th multi-channel gating circuit 201 is electrically connected to the touch fan-out line TX through a first connection line 71; the (m+1)-th multi-channel gating circuit 201 is electrically connected to the touch fan-out line TX through a second connection line 72; the touch display panel includes a first conductive layer Ml and a second conductive layer M2 that are insulated and spaced apart from each other; the first conductive layer M1 includes the first connection lines 71, and the second conductive layer M2 includes the second connection line 72.

In some embodiments, as shown in FIGS. 9 and 15, when the two adjacent touch fan-out lines TX cross each other and are connected to the different multi-channel gating circuits 201 through connection lines respectively, the m-th multi-channel gating circuit 201 with the serial number of m in the j-th multi-channel gating circuit group 200 is electrically connected to the touch fan-out line TX with the serial number of m+1 in the j-th touch fan-out line group 70 through the first connection line 71; the (m+1)-th multi-channel gating circuit 201 with the serial number of m+1 in the j-th multi-channel gating circuit group 200 is electrically connected to the touch fan-out line TX with the serial number of m in the j-th touch fan-out line group 70 through the second connection line 72. For example, as shown in FIG. 9, in the second multi-channel gating circuit group 200, the first multi-channel gating circuit 201 is electrically connected to the second touch fan-out line TX4 in the second touch fan-out line group 70 through the first connection line 71, and the second multi-channel gating circuit 201 is electrically connected to the first touch fan-out line TX3 in the second touch fan-out line group 70 through the second connection line 72. In this case, the first connection line 71 and the second connection line 72 cross each other. To prevent the first connection line 71 and the second connection line 72 from short-circuiting, the first connection line 71 and the second connection line 72 may be arranged in different film layers respectively.

Accordingly, the touch display panel includes a base substrate 80 and multiple conductive layers stacked on a side of the base substrate 80; two adjacent conductive layers are insulated and spaced apart from each other by an insulating layer 81. In this embodiment, the multiple conductive layers include the first conductive layer M1 and the second conductive layer M2, and the first conductive layer M1 and the second conductive layer M2 may be two conductive layers adjacent or spaced apart, which is not limited in this embodiment. The first connection line 71 and the second connection line 72 are located in the preceding two conductive layers respectively, thereby ensuring that the first connection line 71 and the second connection line 72 are insulated from each other and lowering the probability of the short circuit between the adjacent touch fan-out lines TX.

The cross-sectional diagram shown in FIG. 15 shows part of the film layer structure of the touch display panel, such as part of a drive circuit film layer, and does not show display-related film layers such as a liquid crystal layer. The other film layer structures not shown may be disposed according to the actual needs, which is not repeated and limited in the embodiment of the present disclosure.

In one or more embodiments, with continued reference to FIG. 15, in some embodiments of the present disclosure, the first conductive layer M1 or the second conductive layer M2 also includes the touch fan-out lines TX.

Exemplarily, the first connection line 71 or the second connection line 72 may be disposed in the same layer as the touch fan-out line TX so that the first connection line 71 or the second connection line 72 can be prepared in the same process as the touch fan-out line TX, thereby simplifying the preparation process, reducing the difficulty of connecting the connection line and the touch fan-out line TX, and enabling a thinner touch display panel.

FIG. 15 exemplarily shows that the touch fan-out lines TX are located in the second conductive layer M2, which is not actually limited thereto. Additionally, in one or more embodiments not shown in the present disclosure, the touch display panel may also include a third conductive layer; the third conductive layer is insulated from both the first conductive layer M1 and the second conductive layer M2, and the touch fan-out lines TX may be located in the third conductive layer. The touch fan-out line TX, the first connection line 71, and the second connection line 72 are disposed in different layers so that the number of wires arranged in each conductive layer can be reduced, thereby reducing the wiring difficulty.

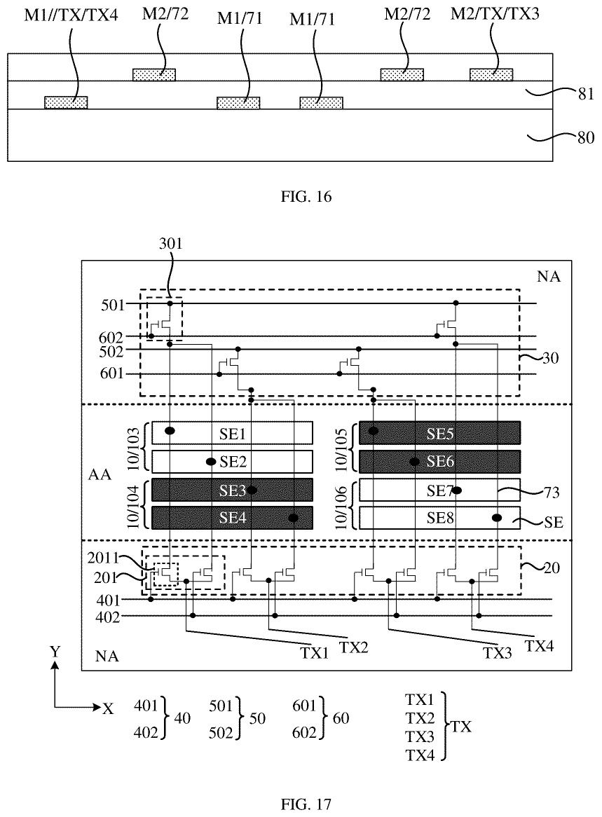

In another embodiment of the present disclosure, FIG. 16 is another cross-sectional diagram of FIG. 9 taken along an A-A′ direction. Referring to FIG. 16, the first conductive layer M1 also includes the touch fan-out line TX electrically connected to the first connection line 71; and/or the second conductive layer M2 also includes the touch fan-out line TX electrically connected to the second connection line 72.

Exemplarily, the touch fan-out lines TX may include a first-type touch fan-out line (for example, the touch fan-out line TX4 shown in FIGS. 9 and 16) and a second-type touch fan-out line (for example, the touch fan-out line TX3 shown in FIGS. 9 and 16); the first-type touch fan-out line is electrically connected to corresponding gating switches 2011 through the first connection line 71, and the second-type touch fan-out line is electrically connected to corresponding gating switches 2011 through the second connection line 72. In this case, the first connection line 71 and the first-type touch fan-out line may be located in the first conductive layer M1, and the second connection line 72 and the second-type touch fan-out line may be located in the second conductive layer M2. In another possible embodiment, the first connection line 71 and the first-type touch fan-out line may be located in the first conductive layer M1, or the second connection line 72 and the second-type touch fan-out line may be located in the second conductive layer M2. In this manner, the wires electrically connected are disposed in the same conductive layer, and the wires insulated from each other are disposed in different conductive layers so that the probability of the short circuit between adjacent touch fan-out lines TX can be further lowered.

In a possible embodiment, in any one of FIGS. 3 to 14, the first control circuit 20 and the second control circuit 30 are disposed on two opposite sides of the display region AA respectively.

Exemplarily, using FIG. 3 as an example, the first control circuit 20 is located in the non-display region NA below the display region AA, and the second control circuit 30 is located in the non-display region NA above the display region AA, which is not actually limited thereto. The first control circuit 20 and the second control circuit 30 are disposed in the non-display region NA on the two opposite sides of the display region AA. In this arrangement, the bezel width of the touch display panel can be symmetrical, thereby improving the aesthetics of the touch display panel.

In one or more embodiments, with continued reference to any one of FIGS. 3 to 14, the display region AA also includes multiple touch wires 73; the touch wires 73 are electrically connected to the touch electrodes SE in one-to-one correspondence; terminals of the touch wires 73 are electrically connected to the control switches 301 respectively, and the other terminals of the touch wires 73 are electrically connected to the gating switches 2011 respectively.

In some embodiments, the touch wires 73 may extend along the column direction Y and be arranged along the row direction X, and the control switch 301 and the gating switch 2011 are connected to two terminals of a touch wire 73 respectively. In the touch short-circuit detection stage, the second control circuit 30 may be used for transmitting the testing common signals to the touch electrodes SE, and the first control circuit 20 may be combined to perform the short circuit detection on the adjacent touch fan-out lines TX. In the display stage, both the first control circuit 20 and the second control circuit 30 may be used for transmitting the display common signals so that the display common signals can be provided to the touch electrodes SE from both sides of the non-display region NA, which is conducive to a reduction in the voltage drop and ensuring the display effect.

FIGS. 3 to 14 exemplarily show the case where the touch electrodes SE are electrically connected to the control switches 301 in one-to-one correspondence, and the corresponding connection relationship between the touch electrodes SE and the control switches 301 is not limited in the embodiment of the present disclosure. For example, each touch electrode SE may be connected to multiple control switches 301 so that each touch electrode SE can receive different common signals respectively, or each control switch 301 may also be connected to multiple touch electrodes SE so that a common signal can be provided to the multiple touch electrodes SE at the same time. This is not limited in the embodiment of the present disclosure as long as the core inventive points of the embodiments of the present disclosure can be achieved.

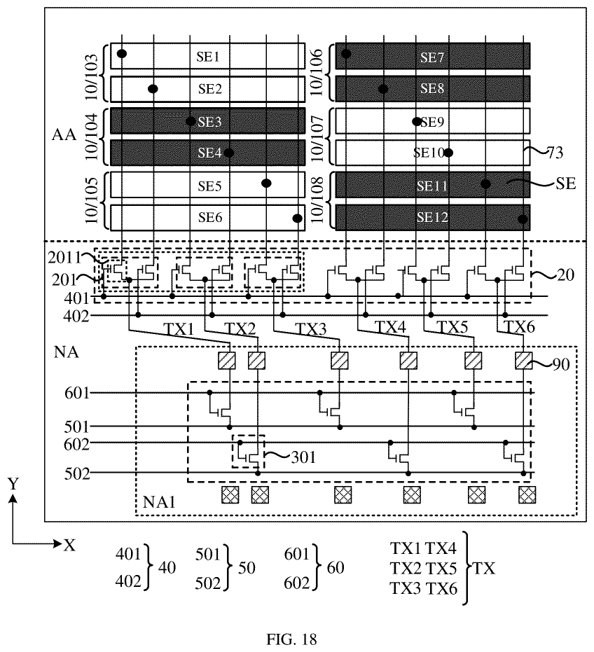

In one or more embodiments, FIG. 17 is yet another diagram illustrating the structure of a touch display panel according to one or more embodiments of the present disclosure; FIG. 18 is still another diagram illustrating the structure of a touch display panel according to one or more embodiments of the present disclosure. Referring to FIGS. 17 and 18, the touch electrodes SE in the same touch electrode group 10 are electrically connected to the same control switch 301.

In some embodiments, as shown in FIGS. 17 and 18, the M touch electrodes SE in the one touch electrode group 10 are electrically connected to the same common signal line 50 through the same control switch 301. In the touch short-circuit detection stage, the touch electrodes SE in the one touch electrode group 10 receive the same testing common signal so that the pixels corresponding to the touch electrodes SE in the same touch electrode group 10 can display the same color. Moreover, since two adjacent touch electrode groups 10 along the row direction X and the column direction Y receive different testing common signals, pixels corresponding to the two adjacent touch electrode groups 10 can display different colors, thereby presenting a checkerboard pattern in units of the touch electrode group 10.

Exemplarily, using the touch display panel shown in FIG. 17 as an example, touch electrodes SE in a first touch electrode group 103 (or a fourth touch electrode group 106) are electrically connected to the second switch control line 602 and the first common signal line 501 through a control switch 301; touch electrodes SE in a second touch electrode group 104 (or a third touch electrode group 105) are electrically connected to the first switch control line 601 and the second common signal line 502 through a control switch 301, and so on. FIG. 17 shows an example that the same column includes two touch electrode groups 10 for description, which is not actually limited thereto. Using the touch display panel shown in FIG. 18 as an example, touch electrodes SE in the first touch electrode group 103 (the third touch electrode group 105 or a fifth touch electrode group 107) are electrically connected to the first switch control line 601 and the first common signal line 501 through a control switch 301; touch electrodes SE in the second touch electrode group 104 (the fourth touch electrode group 106 or a sixth touch electrode group 108) are electrically connected to the second switch control line 602 and the second common signal line 502 through a control switch 301, and so on. FIG. 18 shows an example that the same column includes three touch electrode groups 10 for description, which is not actually limited thereto. In this manner, the touch electrodes SE in the same touch electrode group 10 are electrically connected to the same control switch 301 so that on the basis of performing the short-circuit detection on some touch fan-out lines TX, the number of control switches 301 can be reduced, the layout of the second control circuit 30 can be optimized, and the structure of the touch display panel can be simplified.

Using the touch display panel shown in FIG. 18 as an example, in the touch short-circuit detection stage, when the first switch control line 601 and the second switch control line 602 transmit the enable levels of the switch control signals, all the control switches 301 are turned on. The first common signal line 501 may transmit the high-level testing common signal (for example, the voltage of 5 V), and the second common signal line 502 may transmit the low-level testing common signal (for example, the voltage of 0 V). Moreover, the enable level of the gating control signal is provided to at least one of the first gating control line 401 or the second gating control line 402 so that at least some gating switches 2011 can be turned on. In this case, whether two adjacent touch fan-out lines TX are short-circuited can be determined according to the display colors of two touch electrode groups 10 of the two adjacent touch fan-out lines TX. Using the case where both the first gating control line 401 and the second gating control line 402 transmit the enable levels of the gating control signals and all the gating switches 2011 are turned on as an example, for the multiple touch fan-out lines TX in the same touch fan-out line group 70, if the touch fan-out line TX1 and the touch fan-out line TX2 are not short-circuited, the display colors of pixels corresponding to the touch electrode SE1 and the touch electrode SE2 are white, and the display colors of pixels corresponding to the touch electrode SE3 and the touch electrode SE4 are black; if the touch fan-out line TX1 and the touch fan-out line TX2 are short-circuited, the display colors of the pixels corresponding to the touch electrode SE1 to the touch electrode SE4 are all gray. The manners for detecting the short-circuit between the touch fan-out line TX2 and the touch fan-out line TX3, the short-circuit between the touch fan-out line TX4 and the touch fan-out line TX5, and the short-circuit between the touch fan-out line TX5 and the touch fan-out line TX6 are similar. For the adjacent touch fan-out lines TX belonging to the different groups, if the touch fan-out line TX3 and the touch fan-out line TX4 are not short-circuited, the display colors of pixels corresponding to the touch electrode SE5 and the touch electrode SE6 are white, and the display colors of pixels corresponding to the touch electrode SE7 and the touch electrode SE8 are black; if the touch fan-out line TX3 and the touch fan-out line TX4 are short-circuited, display colors of the pixels corresponding to the touch electrode SE5 to the touch electrode SE8 are all gray. The short-circuit detection can be performed on any two adjacent touch fan-out lines TX according to the preceding solution.

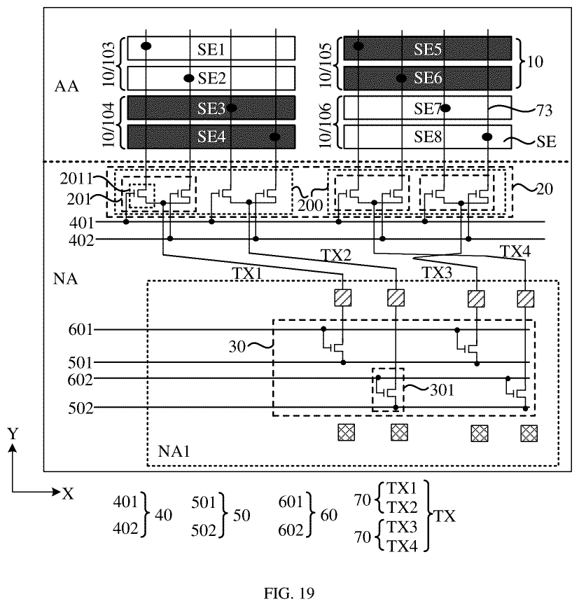

In other optional embodiments, FIG. 19 is still another diagram illustrating the structure of a touch display panel according to one or more embodiments of the present disclosure. As shown in FIG. 19, when the touch electrodes SE in the same touch electrode group 10 are electrically connected to the same control switch 301, and an even number (using two as an example) of touch electrode groups 10 are arranged in the same column, to accurately detect the short circuit between adjacent touch fan-out lines TX belonging to different touch fan-out line groups 70, touch fan-out lines TX corresponding to touch electrode groups 10 located in even-numbered columns need to be exchanged. For example, based on an arrangement sequence from left to right, the first multi-channel gating circuit 201 with the serial number of 1 in the second multi-channel gating circuit group 200 is electrically connected to the touch fan-out line TX4 with the serial number of 2 in the second touch fan-out line group 70, and the second multi-channel gating circuit 201 with the serial number of 2 in the second multi-channel gating circuit group 200 is electrically connected to the touch fan-out line TX3 with the serial number of 1 in the second touch fan-out line group 70. For the specific replacement solution, references can be made to the preceding description, and details are not repeated here.

In other optional embodiments, in conjunction with reference to FIG. 18 or 19, the first control circuit 20 and the second control circuit 30 are disposed on the same side of the display region AA.

Exemplarily, the first control circuit 20 and the second control circuit 30 are located in the non-display region NA on the same side of the display region AA, for example, in the non-display region NA below the display region AA, which is not limited thereto. The first control circuit 20 and the second control circuit 30 are disposed as a whole in the non-display region NA on the same side of the display region AA, without occupying the area of another non-display region NA, which is conducive to a reduction in the width of another non-display region NA.

The arrangement sequence of the first control circuit 20 and the second control circuit 30 along the column direction Y is not limited. The embodiments shown in FIGS. 18 and 19 exemplarily show that the second control circuit 30 is located on a side of the first control circuit 20 facing away from the display region AA, which is not actually limited thereto. The advantage of this arrangement is that the extension length of the touch fan-out line TX and the loss of the touch signal during transmission can be reduced.

In one or more embodiments, with continued reference to FIG. 18 or 19, an output terminal of the control switch 301 is electrically connected to a touch electrode SE through a touch fan-out line TX and a multi-channel gating circuit 201 sequentially.

In some embodiments, as shown in FIG. 18 or 19, when the second control circuit 30 is disposed on the side of the first control circuit 20 facing away from the display region AA, the control switches 301 may be directly electrically connected to the touch wires 73 using the touch fan-out lines TX and the multi-channel gating circuits 201. In other words, the control switches 301 in the second control circuit 30 are electrically connected to corresponding touch electrodes SE through the touch fan-out lines TX and the gating switches 2011. In this manner, the touch fan-out lines TX and the gating switches 2011 are also used as signal transmission lines between the second control circuit 30 and the touch electrodes SE, which can reduce the number of wires and simplify the structure of the touch display panel.

In one or more embodiments not shown in drawings of the present disclosure, the non-display region NA further includes the signal transmission lines (not shown in the drawings), the output terminals of the control switches 301 are electrically connected to the touch wires 73 through the signal transmission lines, and the signal transmission lines are insulated from the touch fan-out lines TX. The control switches 301 are electrically connected to the touch electrodes SE by using the additional signal transmission lines, and the extension length of a signal transmission line is short, which is conducive to a reduction in the loss of a signal during transmission.

In one or more embodiments, with continued reference to FIG. 18 or 19, the non-display region NA further includes a driver chip disposition region NA1; the driver chip disposition region NA1 is provided with multiple touch terminals 90; the touch terminals 90 are electrically connected to the touch fan-out lines TX respectively; the control switches 301 are electrically connected to the touch fan-out lines TX through the touch terminals 90 respectively.

In some embodiments, as shown in FIG. 18 or 19, the driver chip disposition region NA1 may be disposed on the same side as the first control circuit 20 and the second control circuit 30 and is configured to bind the driver chip (not shown in the figure). Exemplarily, the driver chip disposition region NA1 may be located on the side of the first control circuit 20 facing away from the display region AA.

The driver chip disposition region NA1 includes the multiple touch terminals 90, and the touch terminals 90 may be electrically connected to the touch fan-out lines TX in one-to-one correspondence. The driver chip is electrically connected to the touch fan-out lines TX through the touch terminals 90, and the touch signals may be provided by the driver chip to the touch electrodes SE. At least some structures in the second control circuit 30 may be located on sides of the touch terminals 90 facing away from the display region AA, and the control switches 301 may be electrically connected to the touch fan-out lines TX through the touch terminals 90 respectively, thereby electrically connecting the control switches 301 to the touch electrodes SE.

The touch terminals 90 may be arranged along the row direction X. Only some, not all, of the touch terminals 90 are shown in FIGS. 18 and 19. In one or more embodiments, in the embodiments shown in FIGS. 18 and 19, in the orthographic projection of the plane on which the touch display panel is located, the second control circuit 30 is located on a side of the straight line where the touch terminals 90 are located, and the side is facing away from the first control circuit 20. The touch terminals 90 may serve as a boundary between the first control circuit 20 and the second control circuit 30 to separate the first control circuit 20 and the second control circuit 30, thereby optimizing the structural layout in the non-display region NA.

The preceding example illustrates the case where both the first control circuit 20 and the second control circuit 30 are located in the touch display panel. In other optional embodiments of the present disclosure, the first control circuit 20 and/or the second control circuit 30 may also be located in the flexible circuit board or the driver chip, which may be designed according to the actual needs and is not limited in the embodiment of the present disclosure.

As a feasible embodiment, the non-display region NA further includes the driver chip disposition region NA1; the driver chip disposition region NA1 is configured to dispose the driver chip; the second control circuit 30 is integrated into the driver chip.

In some embodiments, the control switches 301 in the second control circuit 30 may be integrated into the driver chip, the common signal lines 50 and the switch control lines 60 are located in the touch display panel, and the common signal lines 50 and the switch control lines 60 are electrically connected to the control switches 301 in the driver chip through corresponding terminals respectively. Integrating the second control circuit 30 into the driver chip can reduce the space occupied in the touch display panel and save more space for other wires and structures.

The touch display panel provided in the embodiments of the present disclosure may further include any structure known to those skilled in the art, which is neither described in detail nor limited in the embodiments of the present disclosure.

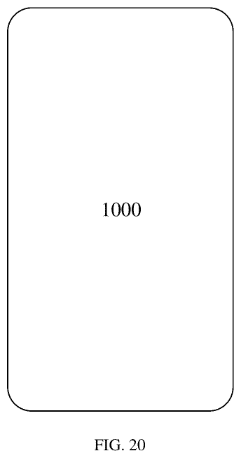

Based on the same inventive concept, one or more embodiments of the present disclosure further provide a touch display device. FIG. 20 is a diagram illustrating the structure of a touch display device according to one or more embodiments of the present disclosure. As shown in FIG. 20, the touch display device includes the touch display panel 1000 provided in any embodiment of the present disclosure. Therefore, the touch display device provided in the embodiment of the present disclosure has the beneficial effects of the touch display panel provided in any embodiment of the present disclosure. The beneficial effects are not repeated here. Exemplarily, the touch display device may be an electronic device such as a mobile phone, a computer, a smart wearable device (such as a smartwatch), or an in-vehicle display device, which is not limited in the embodiments of the present disclosure.

What is claimed is:

1. A touch display panel, comprising a display region and a non-display region surrounding the display region,
wherein the display region comprises a plurality of touch electrodes arranged in an array; among the plurality of touch electrodes, M adjacent touch electrodes form a touch electrode group; M is a positive integer greater than or equal to 2;
wherein the non-display region comprises a first control circuit, a second control circuit, a plurality of gating control lines, a plurality of common signal lines, a plurality of switch control lines, and a plurality of touch fan-out lines;
wherein the first control circuit comprises a plurality of multi-channel gating circuits; a multi-channel gating circuit of the plurality of multi-channel gating circuits comprises a plurality of gating switches; in a same multi-channel gating circuit, control terminals of the plurality of gating switches are electrically connected to different ones of the plurality of gating control lines respectively, first terminals of the plurality of gating switches are electrically connected to a same one of the plurality of touch fan-out lines, and second terminals of the plurality of gating switches are electrically connected to touch electrodes in a same touch electrode group respectively; and
wherein the second control circuit comprises a plurality of control switches; control terminals of the plurality of control switches are electrically connected to the plurality of switch control lines, input terminals of the plurality of control switches are electrically connected to the plurality of common signal lines, and output terminals of the plurality of control switches are electrically connected to the plurality of touch electrodes respectively, wherein among the plurality of control switches, control switches electrically connected to adjacent touch electrodes belonging to different touch electrode groups are electrically connected to different ones of the plurality of common signal lines respectively, and are electrically connected to different ones of the plurality of switch control lines respectively.

2. The touch display panel of claim 1, wherein at least one of the following configurations is satisfied:
control switches, electrically connected to touch electrodes in a same row in a same touch electrode group, are electrically connected to a same one of the plurality of switch control lines and a same one of the plurality of common signal lines; or
control switches, electrically connected to touch electrodes in a same column in a same touch electrode group, are electrically connected to a same one of the plurality of switch control lines and a same one of the plurality of common signal lines.

3. The touch display panel of claim 2, wherein gating switches electrically connected to two touch electrodes, that are adjacent in the same column and belong to different touch electrode groups, are electrically connected to different ones of the plurality of gating control lines respectively.

4. The touch display panel of claim 1, wherein control switches electrically connected to touch electrodes that are adjacent and belong to a same touch electrode group, are electrically connected to different ones of the plurality of common signal lines respectively.

5. The touch display panel of claim 4, wherein the control switches electrically connected to the touch electrodes that are adjacent and belong to the same touch electrode group, are electrically connected to different ones of the plurality of switch control lines respectively.

6. The touch display panel of claim 4, wherein two adjacent touch electrode groups are provided, and the two adjacent touch electrode groups comprise a first-type touch electrode group and a second-type touch electrode group respectively; the first-type touch electrode group comprises a first touch electrode, and the second-type touch electrode group comprises a second touch electrode;
a control switch corresponding to the first touch electrode and a control switch corresponding to the second touch electrode are electrically connected to different ones of the plurality of common signal lines respectively; and
a gating switch corresponding to the first touch electrode and a gating switch corresponding to the second touch electrode are electrically connected to a same one of the plurality of gating control lines.

7. The touch display panel of claim 1, wherein multi-channel gating circuits electrically connected to touch electrode groups located in a same column form a multi-channel gating circuit group; in a same multi-channel gating circuit group, a multi-channel gating circuit electrically connected to a touch electrode group located in an i-th row is an i-th multi-channel gating circuit; when a number of touch electrode groups located in the same column is N, 1≤i≤N, and i and N are both positive integers; and
along a row direction of the plurality of touch electrodes, the plurality of touch fan-out lines are arranged sequentially; among the plurality of touch fan-out lines, N adjacent touch fan-out lines form a touch fan-out line group; the touch fan-out lines in the same touch fan-out line group are electrically connected to the multi-channel gating circuits in the same multi-channel gating circuit group respectively, wherein two adjacent touch fan-out lines belonging to different touch fan-out line groups are electrically connected to an s-th multi-channel gating circuit and a k-th multi-channel gating circuit respectively; wherein, 1≤s≤N, 1≤k≤N, and s and k are both even numbers or odd numbers.

8. The touch display panel of claim 7, wherein
N is an even number, in a multi-channel gating circuit group corresponding to touch electrode groups located in a j-th column, an m-th multi-channel gating circuit is electrically connected to a touch fan-out line with a serial number of m+1 in a j-th touch fan-out line group, and an (m+1)-th multi-channel gating circuit is electrically connected to a touch fan-out line with a serial number of m in the j-th touch fan-out line group, wherein 1≤m≤N, m is an odd number, and j is an even number; or
N is an odd number, in the multi-channel gating circuit group corresponding to the touch electrode groups located in a j-th column, an m-th multi-channel gating circuit is electrically connected to a touch fan-out line with a serial number of m+1 in a j-th touch fan-out line group, and an (m+1)-th multi-channel gating circuit is electrically connected to a touch fan-out line with a serial number of m in the j-th touch fan-out line group, wherein 1≤m<N, m is an odd number, and j is a positive integer greater than 1.

9. The touch display panel of claim 8, wherein the non-display region further comprises a plurality of first connection lines and a plurality of second connection lines that are insulated from each other;
the m-th multi-channel gating circuit is electrically connected to the touch fan-out line through a first connection line of the plurality of first connection lines;
the (m+1)-th multi-channel gating circuit is electrically connected to the touch fan-out line through a second connection line of the plurality of second connection lines; and
the touch display panel comprises a first conductive layer and a second conductive layer that are insulated and spaced apart from each other; the first conductive layer comprises the plurality of first connection lines, and the second conductive layer comprises the plurality of second connection lines.

10. The touch display panel of claim 9, wherein one of the first conductive layer or the second conductive layer further comprises the plurality of touch fan-out lines.

11. The touch display panel of claim 9, wherein at least one of the following configurations is satisfied:
the first conductive layer further comprises touch fan-out lines electrically connected to the first connection lines; or
the second conductive layer further comprises touch fan-out lines electrically connected to the second connection lines.

12. The touch display panel of claim 1, wherein the first control circuit and the second control circuit are disposed on two opposite sides of the display region respectively.

13. The touch display panel of claim 12, wherein the display region further comprises a plurality of touch wires; the plurality of touch wires are electrically connected to the plurality of touch electrodes in one-to-one correspondence; and
a terminal of a touch wire of the plurality of touch wires is electrically connected to a control switch of the plurality of control switches, and another terminal of the touch wire of the plurality of touch wires is electrically connected to a gating switch of the plurality of gating switches.

14. The touch display panel of claim 1, wherein the touch electrodes in the same touch electrode group are electrically connected to a same one of the plurality of control switches.

15. The touch display panel of claim 14, wherein the first control circuit and the second control circuit are disposed on a same side of the display region.

16. The touch display panel of claim 15, wherein an output terminal of a control switch of the plurality of control switches is electrically connected to a touch electrode of the plurality of touch electrodes through a touch fan-out line of the plurality of touch fan-out lines and a multi-channel gating circuit of the plurality of multi-channel gating circuits sequentially.

17. The touch display panel of claim 16, wherein the non-display region further comprises a driver chip disposition region; the driver chip disposition region is provided with a plurality of touch terminals; the plurality of touch terminals are electrically connected to the plurality of touch fan-out lines respectively; and
the plurality of control switches are electrically connected to the plurality of touch fan-out lines through the plurality of touch terminals respectively.

18. The touch display panel of claim 1, wherein the non-display region further comprises a driver chip disposition region; the driver chip disposition region is configured to dispose a driver chip; the second control circuit is integrated into the driver chip.

19. The touch display panel of claim 1, wherein a working stage of the touch display panel comprises a touch short-circuit detection stage, in the touch short-circuit detection stage, the plurality of common signal lines are configured to transmit different common signals respectively.

20. A touch display device, comprising a touch display panel comprising a display region and a non-display region surrounding the display region;
wherein the display region comprises a plurality of touch electrodes arranged in an array; among the plurality of touch electrodes, M adjacent touch electrodes form a touch electrode group; M is a positive integer greater than or equal to 2;
wherein the non-display region comprises a first control circuit, a second control circuit, a plurality of gating control lines, a plurality of common signal lines, a plurality of switch control lines, and a plurality of touch fan-out lines;
wherein the first control circuit comprises a plurality of multi-channel gating circuits; a multi-channel gating circuit of the plurality of multi-channel gating circuits comprises a plurality of gating switches; in a same multi-channel gating circuit, control terminals of the plurality of gating switches are electrically connected to different ones of the plurality of gating control lines respectively, first terminals of the plurality of gating switches are electrically connected to a same one of the plurality of touch fan-out lines, and second terminals of the plurality of gating switches are electrically connected to touch electrodes in a same touch electrode group respectively; and
wherein the second control circuit comprises a plurality of control switches; control terminals of the plurality of control switches are electrically connected to the plurality of switch control lines, input terminals of the plurality of control switches are electrically connected to the plurality of common signal lines, and output terminals of the plurality of control switches are electrically connected to the plurality of touch electrodes respectively, wherein among the plurality of control switches, control switches electrically connected to adjacent touch electrodes belonging to different touch electrode groups are electrically connected to different ones of the plurality of common signal lines respectively, and are electrically connected to different ones of the plurality of switch control lines respectively.
